(19) United States
(12) Patent Application Publication
(10) Pub. No.: US 2026/0346227 A1
(43) Pub. Date: Nov. 5, 2026

(54) IMPROVEMENTS IN AND RELATING TO SORBENTS FOR CAPTURE OF A GAS SUCH AS CARBON DIOXIDE FROM A GAS STREAM

(71) Applicant: The Trustees of Columbia University in the City of New York, New York, NY (US)

(72) Inventors: XIAOYANG SHI, NY, NY (US); MENGQI SHEN, Quincy, MA (US); AH-HYUNG ALISSA PARK, Los Angeles, CA (US)

(73) Assignee: The Trustees of Columbia University in the City of New York, New York, NY (US)

(21) Appl. No.: 19/487,628

(22) PCT Filed: May 24, 2024
(86) PCT No.: PCT/US2024/030934

§ 371 Date: Nov. 25, 2025

Related U.S. Application Data
(60) Provisional application No. 63/468,850, filed on May 25, 2023.

(51) Int. Cl. B01J 20/22; B01D 53/02; B01J 20/30

(52) U.S. Cl. CPC B01J 20/22; B01D 53/02; B01J 20/3085; B01D 2253/20; B01D 2257/504

(57) ABSTRACT

Compositions, methods of production, methods of use, and systems for use of a humidity swing sorbent can have applications in the capture of carbon dioxide or other target chemicals from the air or other gas streams. The compositions, methods, and systems can use a humidity swing sorbent that includes a sorbent carrier layer of an oxide nanoparticle material or a nanoporous material, and a capture layer, the capture layer comprising a set of neutral ionic pairs with at least one cation and at least one anion, wherein the set of neutral ionic pairs are spatially distributed on scaffolding of the oxide material such that the anions of each neutral ionic pair is spaced for formation of a hydration shell around each anion, wherein the hydration shell around the anion is a carbon diox-ide adsorption site.

### CROSS-REFERENCE TO RELATED APPLICATIONS

This Application claims the benefit of U.S. Provisional Application No. 63/468,850, filed on 25 May 2023, which is incorporated in its entirety by this reference.

### BACKGROUND

Climate change needs translational engineering solutions to address the excess CO₂ that has already been added to the atmosphere. The urgency of CO₂ capture from ambient air has been well established. However, acceptance of such technologies of Direct Air Capture (DAC) of CO, is still limited due to the cost and technical difficulty of solving this problem. There are many benefits in CO₂ elimination including but not limited to: mitigating effects on global climate change, improving public health, maintaining animals and plant diversity, and other environmental benefits. CO₂ conversion to synthetic fuel is also one of the most important goals on the United Nations' sustainable development agenda.

There are many challenges in the area of DAC. As one challenge, the CO₂ concentration in the air is low and therefore can be hard to capture. Another challenge, traditional materials used in existing DAC technologies have many limitations.

There are, in general, five types of existing DAC technologies, including physical sorption, sorption by strong bases, sorption by amine-modified materials, sorption by aqueous amino acid solution followed by precipitation into a guanidine compound, and electrochemistry. However, traditional materials used as sorbents in these DAC technologies are not stable, difficult to scale up, have low selectivity (sometimes taking up large amounts of water from the air), and/or have a high energy cost (e.g., for regeneration of materials).

Many physical sorption sorbents also capture H₂O from the air when capturing CO₂, and air humidity levels can have a deleterious effect on CO₂ sorption capacity. As another example, most commonly used amine-modified materials have a significant degradation issue during the heating process (used for regeneration after CO₂ capture). It will be necessary for DAC sorbents to be capable of many thousands of cycles without undue loss of performance, in order to reduce the capture price per ton of CO₂ to drop below $100, which is needed in order to provide an economically viable process.

One exemplary capture method disclosed in U.S. Pat. No. 9,283,510 used a polymer-based amine-based anion exchange resin to capture CO₂ directly from the air. However, such resins have been found to have undesirable CO₂ adsorption/desorption kinetics. As a result, adsorption/desorption cycle times are long, taking ten hours or more (as shown in FIG. 1).

Accordingly, the material limitations of such resins pose serious limitations to practical viability of such a solution.

Thus, there is a desire in the carbon capture technology field to create compositions, methods, and systems for a humidity swing sorbent usable for direct air capture of carbon dioxide.

### SUMMARY

Aspects of the present disclosure relate generally to the field of gas adsorption technologies, such as carbon capture technologies and more specifically to a new and useful compositions, methods, and systems for a humidity swing sorbent usable for direct air capture of carbon dioxide. To address problems in the field of carbon capture and/or the capture of other target gases (such as toxic gases), some aspects of the present disclosure are directed to a humidity swing sorbent for direct air capture CO₂ and CO₂ capture from flue gas as well as controlled release of CO₂ and reuse of the humidity swing sorbent. The humidity swing sorbent can have similar capabilities for other target gases.

Some aspects of the present disclosure are directed to a series of ion-functionalized sorbent materials that promote reactions responsive to a humidity swing for the capture and release of target gases and in particular capture and release of CO₂. Such aspects can have ion-functionalized materials that use a carrier layer as a scaffold for establishing a capture layer with spaced displacement of different ionic pairs (or ionic assemblies) about which a hydration shell can form and be used as a mechanism for capture of CO₂ based on a humidity swing. A carrier layer can also be referred to as a substrate material.

The present disclosure is configured to use of a sorbent of ion-functionalized materials to chemically capture CO₂ from the air in a dry condition, and release CO₂ in the presence of an increased amount of water (humidity swing). Returning the sorbent to dry conditions can regenerate the sorbent, wherein the regenerated sorbent can capture CO₂ from ambient air after drying. It will be appreciated that as used herein, ‘dry’ and ‘wet’ conditions are relative. For example, it can be that a material is considered ‘dry’ provided that is comprises less water than a material considered ‘wet’, and it can be that a ‘wet’ material is not saturated with water. Compared with the state-of-art resin materials, the present disclosure's sorbents can exhibit significantly enhanced CO₂ capture and regeneration kinetics and/or other benefits. Some aspects can use carrier layer materials of a nanoporous or mesoporous structure such as using a mesoporous oxide. Some aspects can use oxide nanoparticles as the carrier layer.

Advantageously, it has been found that sorbent materials of the present disclosure can be dried simply by passing ambient air over the sorbent material. As the sorbent material returns to its ‘dry’ state, the sorbent begins adsorbing CO₂ from the air. Thus, it can be that no special ‘drying’ treatment is required. Instead, the sorbent of the present disclosure can be simply (re)exposed to e.g. ambient air containing CO₂ for removal after wetting to release previously captured CO₂.

According to a first aspect of the disclosed subject matter, a sorbent composition for use in adsorption of a target gas from a gas stream is provided. The sorbent composition can include a covalent network solid oxide substrate material functionalized with an ionic linker moiety. The substrate can alternatively be referred to as a sorbent carrier layer. The sorbent composition can optionally be described as a humidity swing sorbent composition. Optionally, each ionic linker moiety comprises: a multivalent anion, and a polyatomic cation. Optionally, the polyatomic cation is selected from ammonium, phosphonium, arsonium, stibonium, bismuthium and sulfonium. Optionally, the polyatomic cation is connected to an oxygen atom on a surface of the substrate material by a covalent bond. According to a second aspect of the disclosed subject matter, a sorbent precursor for a sorbent composition for use in adsorption of a target gas from a gas stream is provided. Optionally, the sorbent precursor is a precursor for said sorbent composition of the first aspect of the disclosed subject matter. Optionally, the sorbent precursor comprises the covalent network solid oxide substrate material functionalized with an ionic linker precursor. Optionally, the linker precursor comprises a monovalent anion, and the polyatomic cation, optionally connected to an oxygen atom on a surface of the substrate material by a covalent bond. Optionally, the target gas is carbon dioxide.

Optionally, the polyatomic cation has the formula R(R′)ₓA⁺. Optionally, R is a hydrocarbyl-containing group connected to an oxygen atom on a surface of the substrate material by a covalent bond, or R is a covalent bond to an oxygen atom on a surface of the substrate material. R is an optionally substituted C1 to C8 hydrocarbyl group Optionally, each R′ is independently a hydrocarbyl-containing group or H. Optionally, R′ is a C1 to C6 alkyl group (such as methyl, ethyl, propyl or butyl), or R′ is an aryl group (such as phenyl). Optionally, x is 3 and A is N, P, As, Sb or Bi. Optionally, x is 2 and A is S. Optionally, the polyatomic cation is ammonium, phosphonium or sulfonium. Optionally the polyatomic cation is an ammonium cation, such as a quaternary ammonium cation, for example a trimethylammonium-containing cation.

Optionally, the polyatomic cations are spaced apart on a surface (e.g. in a pore) of the covalent network solid oxide material, for example wherein the average spacing of no more than about 50 Å (angstroms), such as no more than about 20 Å, for example no more than about 10 Å. Additionally or alternatively, the polyatomic cations are spaced apart by a distance of from about 4 to about 50 Å (angstroms), such as about 6 to 20 Å, for example about 8 to 10 Å.

It will be understood that a multivalent anion has a multiple negative charge, such as 2-, 3- or 4-. Optionally, the multivalent anion comprises or consists of oxygen and an element from Group 15 or Group 16 of the period table. Optionally, the multivalent anion is selected from: BO₃³⁻, CO₃², C₂O₄²⁻, SiO₄⁴⁻, PO₃³⁻, PO₄³⁻, SO₃²⁻ and SO₄²⁻. Optionally, the multivalent anion comprises or consists of hydrogen, oxygen and an element from Group 15 or Group 16 of the periodic table, for example wherein the multivalent anion is selected from: HBO₃²⁻, HCO₃₋, HC₂O₄₋, HSiO₄³⁻, HPO₃⁻, HPO₄²⁻, HSO₃₋ and HSO₄₋. Optionally, the sorbent composition further comprises an anion of the formula (TG)OH⁻, wherein TG is the target gas, and wherein (TG)OH⁻ and the multivalent anion are present in a molar ration of about 1:1. Optionally, the target gas is CO₂ and (TG)OH⁻ is HCO₃₋ Optionally, the sorbent composition comprises the multivalent anion in an amount of from about 0.2 mmol to about 3 mmol, such as from about 0.3 to about 2.5 mmol, for example from about 0.5 to about 2 mmol, per gram of covalent network solid oxide material.

Optionally, the substrate material is functionalized by reaction of each said oxygen on the surface of the substrate material with a carbon atom of a linker precursor reactant susceptible to nucleophilic attack, thereby forming the C—O covalent bond. Optionally, the linker precursor reactant comprises a cation selected from N-[3-(Trimethoxysilyl)propyl]-N,N,N-trimethylammonium, N-(Trimethoxysilylpropyl)-N,N,N-trimethylphosphonium and glycidyltrimethylammonium. Optionally, the substrate material is functionalized by reaction of each said oxygen on the surface of the substrate material with an epoxide group of a linker precursor reactant, thereby forming the C—O covalent bond. For example, it can be that a hydroxide group on the surface of the substrate forms a O—C covalent bond by a ring-opening reaction with an epoxide group. Optionally, the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond.

Optionally, the covalent network solid oxide substrate material comprises one or more of silica, alumina, ceria, zirconia, iron oxide and aluminosilica.

Optionally, the sorbent composition comprises water. Optionally water is present in a molar ratio of water: multivalent anion of from 1:10 to 40:1, such as 1:1 to 1:20. Such a water content of the sorbent composition will be understood to be a ‘dry’ state of the sorbent composition, in which water is present at a concentration low enough for water molecules to form a stable hydration shell around a multivalent anion (as described in more detail hereinbelow). When the sorbent is in a dry state, the sorbent can be configured for target gas adsorption (e.g. CO₂ capture). Alternatively, water is present in a molar ratio of water: multivalent anion of greater than 40:1, such as at least 50:1. Such a water content of the sorbent composition will be understood to be a ‘wet’ state of the sorbent composition, in which water is present at a concentration at which such hydration shells are disrupted. When the sorbent is in a wet state, the sorbent can be configured for target gas desorption (e.g. CO₂ release).

According to a third aspect of the disclosed subject matter, a composition for a sorbent used for adsorption of carbon dioxide is provided. The composition can include a sorbent carrier layer; and a capture layer, the capture layer including an ion-modified material having at least one carbon dioxide adsorption site thereon. It will be appreciated that the ion-modified material can, for example, for a discontinuous layer, such as being formed by deposits of the ion-modified material on the surface of the sorbent carrier layer. The ion-modified material can also be referred to as the ‘ionic pair'. It can be that the term 'ionic pair’ refers to a neutral ionic material comprising one or more cations and one or more anions ionically bonded and charge balanced. Optionally, the at least one anion of the ionic pair is a multivalent anion. Optionally, the ion-modified material comprises the polyatomic cation and/or the multivalent anion as described hereinabove. It will be appreciated that an aspect or embodiment of the disclosed subject matter can incorporate any feature disclosed in relation to another aspect or embodiment of the disclosed subject matter. For example, the sorbent and/or sorbent precursor of the first and second aspects, respectively, can incorporate any feature disclosed in relation to the sorbent of the third aspect, and vice versa.

In some variations, the sorbent carrier layer can be made of an oxide material. It will be understood that an oxide material can be a compound comprising oxygen and at least one other element and which is solid at ambient temperature and pressure. More particularly, it can be that an oxide material is a covalent network solid. Also referred to as atomic crystalline solids or giant covalent structures, a covalent network solid is a chemical compound in which the atoms are bonded by covalent bonds in a continuous network extending throughout the material, e.g. resulting in a crystalline or amorphous macromolecular solid.

In some variations, the sorbent carrier layer is made of a nanoporous material. It will be understood that a nanoporous material is a material having pores with a diameter in the range of about 1 nm to about 1000 nm. In some variations, the sorbent carrier layer is made of a mesoporous material. It will be understood that a mesoporous material is a material having pores with a diameter in the range of about 2 nm to about 50 nm. Pore size can be measured by any suitable method, for example by N₂ adsorption at 77 K.

In some variations, the sorbent carrier layer can be made of an oxide nanoparticle material or a nanoporous material.

In some embodiments, the ion-modified material is a combination of positive charge ions (cations) and negative charge ions (anions).

In some variations, the ion-modified material is comprised of a set of ionic pairs which can be an ion assembly or complex of a combination of ions (cations and anions), which can be neutrally charged. Accordingly, in another aspect of the disclosed subject matter, a composition for a sorbent used for adsorption of carbon dioxide including: a sorbent carrier layer that is made of an oxide material; and a capture layer, the capture layer comprising a set of neutral ionic pairs with at least one cation and at least one anion, wherein the set of neutral ionic pairs are spatially distributed on scaffolding of the oxide material such that the anions of each neutral ionic pair are spaced for formation of a hydration shell around each anion, wherein the hydration shell around the anion is a carbon dioxide adsorption site.

In some embodiments, the oxide material is a nanoporous oxide material.

In some embodiments, the oxide material is a mesoporous oxide material.

In some embodiments, the ion-modified material is contained in pores of the nanoporous oxide material. Optionally, the nanoporous oxide material comprises pores containing the ion-modified material.

In some embodiments, the oxide material is a nanoporous oxide material, and the set of neutral ionic pairs that are spatially distributed on scaffolding of the oxide material are contained in pores of the oxide nanoporous material.

Accordingly, in some embodiments of the disclosed subject matter, a composition for a sorbent used for adsorption of carbon dioxide includes: a sorbent carrier layer that is made of an oxide material; and a capture layer, the capture layer comprising a set of neutral ionic pairs with at least one cation and at least one anion, wherein the set of neutral ionic pairs are contained in pores of the oxide nanoporous material such that the anions of each neutral ionic pair are spaced for formation of a hydration shell around each anion, wherein the hydration shell around the anion is a carbon dioxide adsorption site.

In some variations, the carrier layer can include nanoporous material that is an oxide nanoporous material or a non-oxide nanoporous material. Accordingly, in some embodiments of the disclosed subject matter, a composition for a sorbent used for adsorption of carbon dioxide can include a sorbent carrier layer that is made of a nanoporous material; and a capture layer, the capture layer including an ion-modified material having at least one carbon dioxide adsorption site thereon, and the ion-modified material being contained in pores of the nanoporous material. In some variations of an embodiment, the composition can include: a sorbent carrier layer that is made of a nanoporous material; and a capture layer, the capture layer comprising a set of neutral ionic pairs with at least one cation and at least one anion, wherein the set of neutral ionic pairs are contained in pores of the oxide nanoporous material such that the anions of each neutral ionic pair are spaced for formation of a hydration shell around each anion, wherein the hydration shell around the anion is a carbon dioxide adsorption site.

In some embodiments, the nanoporous material is an oxide nanoporous material.

In some embodiments, the nanoporous material is a non-oxide nanoporous material.

In some embodiments, the nanoporous material is a material comprising or selected from a group consisting of activated carbon, quartz, zeolite, carbon nanotubes, organometallic frame material, and covalent organic frame material.

Optionally, the pores of the nanoporous oxide material comprise, on average, no more than 20 anions of the neutral ionic pairs per pore. In some embodiments, the neutral ionic pairs contained in the pores of the oxide nanoporous material have non-crystalline spacing of anions for hydration shell formation when there are less than 20 anions in a pore. It will be understood that, as used herein, a non-crystalline spacing is a spacing of anions that is greater than that present in a crystalline form of the ionic material. For example, if the ionic material is sodium carbonate, a non-crystalline spacing is a spacing of anions greater than the spacing between carbonate anions in crystalline sodium carbonate. Optionally, non-crystalline spacing is a spacing at least two times, such as at least three times, that of anions in the corresponding crystalline material.

In some embodiments, the oxide material is an oxide nanoparticle material. It will be understood that a nanoparticle material comprises or consists of a particulate material made up of particles having a maximum dimension (e.g. length, width, height, and/or diameter) of 1 to 1000 nm.

In some embodiments, the ion-modified material is bonded to and/or around a surface of a nanoparticle in the oxide nanoparticle material.

In some embodiments, the oxide material is an oxide nanoparticle material, and the set of neutral ionic pairs that are spatially distributed on scaffolding of the oxide material is spaced by each cation of the at least one cation being grafted spatially on an oxide nanoparticle of the oxide nanoparticle material.

Accordingly, in some embodiments of the disclosed subject matter, a composition for a sorbent used for adsorption of carbon dioxide including: a sorbent carrier layer that is made of an oxide material; and a capture layer, the capture layer comprising a set of neutral ionic pairs with at least one cation and at least one anion, wherein each cation of the at least one cation of the set of ionic pairs is grafted spatially on an oxide nanoparticle of the oxide nanoparticle material, such that the anions of each neutral ionic pair are spaced for formation of a hydration shell around each anion, wherein the hydration shell around the anion is a carbon dioxide adsorption site. As used herein, ionic pairs are grafted onto a material (such as a carrier material) when a covalent bond forms between the or each cation of the ionic pair and the material.

In some embodiments, there are multiple neutral ionic pairs that are grafted onto the nanoparticle of the oxide nanoparticle material.

In some embodiments, the neutral ionic pairs are grafted spatially onto or about the oxide nanoparticles such that anions of the neutral ionic pairs have non-crystalline spacing.

In some embodiments, the hydration shell around each anion of the set of neutral ionic pairs is conditional on humidity state. Additionally or alternatively, the number of water molecules comprised in the hydration shell can depend, at least in part, on the relative humidity of the surrounding environment. For example, in conditions of higher humidity, the number of water molecules comprised in the hydration shell can be higher than in conditions of lower humidity. It will be understood that the number of water molecules in a hydration shell can be referred to as the water number, or water molecule number. It will be further understood that the water molecules comprised in a hydration shell are the water molecules held in place by interaction of the water molecules with an anion of the ion-modified material, for example water molecules that form a hydrogen bond with the anion. It will be appreciated that such hydrogen-bonded water molecules can, for example, form an ordered structure around and/or adjacent to the anion. It has been found that allowing the sorbent material of the present disclosure to equilibrate in terms of moisture content in an environment with a relative humidity of no more than 45% will put the sorbent into the ‘dry’ state (i.e. capable of adsorbing a sufficient quantity of CO₂ to provide a commercially viable carbon capture system). It has also been found that when the sorbent equilibrates at a relative humidity >99%, substantially all captured CO₂ will be released.

In some embodiments, when in a condition for a hydration shell based on the water molecule number, presence of carbon dioxide drives a first reaction between carbon dioxide, the hydration shell, and the anion for formation of at least a bicarbonate ion within the hydration shell.

In some embodiments, the condition for the hydration shell based on the water molecule number is when the number of water molecules is less than at least 50. In some embodiments, the condition for the hydration shell based on the water molecule number is when the number of water molecules is less than at least 30. In some embodiments, the condition for the hydration shell based on the water molecule number is when the number of water molecules is less than at least 20. In some embodiments, the condition for the hydration shell based on the water molecule number is when the number of water molecules is less than at least 10. It will be understood that the number of water molecules per anion suitable for forming a stable hydration shell can depend on the anion. For example, it has been found that a carbonate ion can form a hydration shell with fewer water molecules than a phosphate anion. Typical water numbers can be determined by quantum chemistry based on order structure, for example.

In some embodiments, when in a condition for breakdown of the hydration shell based on the water molecule number, the hydration shell breaks down through a second reaction that releases CO₂ from the bicarbonate ion into water (e.g., aqueous water).

In some embodiments, the condition for breakdown of the hydration shell based on the water molecule number is when the number of water molecules is greater than 50. In some embodiments, the condition for breakdown of the hydration shell based on the water molecule number is when the number of water molecules is greater than 30. In some embodiments, the condition for breakdown of the hydration shell based on the water molecule number is when the number of water molecules is greater than 20. In some embodiments, the condition for breakdown of the hydration shell based on the water molecule number is when the number of water molecules is greater than 10.

Adsorption and desorption of CO₂ on the sorbent can be described by the following equilibrium, for example when the anion comprises boron, carbon, silicon, phosphorus or sulfur:

A_{z}Oₓ^{y-}+nH₂O+CO₂ [symbol] HA_{z}Oₓ^{(y-1)-}+HCO₃⁻+(n-1)H₂O

wherein A is B, C, Si, P or S, and x and y are independently at least 2. Optionally, when A is B, x is 3, y is 3 and z is 1. Optionally, when A is C: x is 3, y is 2 and z is 1; or, x is 4, y is 2 and z is 2. Optionally, when A is Si, x is 4, y is 4 and z is 1. Optionally, when A is P: x is 3, y is 3 and z is 1; or, x is 4, y is 3 and z is 1. Optionally, when A is S: x is 3, y is 2 and z is 1; or, x is 4, y is 2 and z is 1. In the equilibrium equation above, the forward reaction of the equilibrium (in which CO₂ is consumed) can be referred to as the first reaction, and the backward reaction (in which CO₂ is produced) can be referred to as the second reaction. It will be appreciated that the position of the equilibrium can govern the CO₂ capture state of the material, and that addition or removal of water from the system can move the equilibrium position toward free CO₂ or toward captured CO₂. More particularly, when water concentration is low, the equilibrium lies to the right, favoring CO₂ capture, while an increase in water concentration moves the equilibrium to the left, favoring CO₂ release.

In some embodiments, the at least one anion is a borate ion (BO₃³⁻), wherein the first reaction is characterized by:

BO₃³⁻+nH₂O+CO₂→HBO₃²⁻HCO₃⁻+(n-1)H₂O,

and the second reaction is characterized by:

HBO₃²⁻HCO₃+(n-1)H₂O→BO₃³⁻+nH₂O+CO₂.

In some embodiments, the at least one anion is a carbonate ion (CO₃²⁻), wherein the first reaction is characterized by:

CO₃²⁻+nH₂O+CO₂→2HCO₃⁻+(n-1)H₂O,

and the second reaction is characterized by:

2HCO₃⁻+(n-1)H₂O→CO₃²⁻+nH₂O+CO₂.

In some embodiments, the at least one anion is an oxalate ion (C₂O₄²⁻), wherein the first reaction is characterized by:

C₂O₄²⁻+nH₂O+CO₂→HC₂O₄⁻HCO₃⁻+(n-1)H₂O,

and the second reaction is characterized by:

HC₂O₄⁻HCO₃⁻+(n-1)H₂O→C₂O₄²⁻+nH₂O+CO₂.

In some embodiments, the at least one anion is a silicate ion (SiO₄⁴⁻), wherein the first reaction is characterized by:

SiO₄⁴⁻+nH₂O+CO₂→HSiO₄³⁻HCO₃⁻+(n-1)H₂O,

and the second reaction is characterized by:

HSiO₄³⁻HCO₃⁻+(n-1)H₂O→SiO₄⁴⁻+nH₂O+CO₂.

In some embodiments, the at least one anion is a sulfite ion (SO₃²⁻), wherein the first reaction is characterized by:

SO₃²⁻+nH₂O+CO₂→HSO₃⁻HCO₃⁻+(n-1)H₂O,

and the second reaction is characterized by:

HSO₃⁻HCO₃⁻+(n-1)H₂O→SO₃²⁻+nH₂O+CO₂.

In some embodiments, the at least one anion is a sulfate ion (SO₄²⁻), wherein the first reaction is characterized by:

SO₄²⁻+nH₂O+CO₂→HSO₄⁻HCO₃⁻+(n-1)H₂O,

and the second reaction is characterized by:

HSO₄⁻HCO₃⁻+(n-1)H₂O→SO₄²⁻+nH₂O+CO₂.

In some embodiments, the at least one anion is a phosphite ion (PO₃²⁻), wherein the first reaction is characterized by:

PO₃³⁻+nH₂O+CO₂→HPO₃⁻HCO₃⁻+(n-1)H₂O,

and the second reaction is characterized by:

HPO₃⁻HCO₃⁻+(n-1)H₂O→PO₃³⁻+nH₂O+CO₂.

In some embodiments, the at least one anion is a phosphate ion (PO₄³⁻), wherein the first reaction is characterized by:

PO₄³⁻+nH₂O+CO₂→HPO₄²⁻HCO₃⁻+(n-1)H₂O,

and the second reaction is characterized by:

HPO₄²⁻HCO₃⁻+(n-1)H₂O→PO₄³⁻+nH₂O+CO₂.

In some embodiments, the hydration shell has 1-3 levels. It will be understood that a level of a hydration shell is a layer of water molecules spaced apart from the anion by about the same distance, with lower levels (inner layers) closer to the anion than upper levels (outer layers). Optionally, the hydration shell comprises a first level, and optionally one or more additional layers. It will be understood that the first level is the layer of water molecules that directly interact with a solute (in this case, the anion). The distance between the solute and the first hydration shell is typically around 2.0 to 3.5 Å (angstroms), depending on the size and charge of the ion. The second level is a layer containing or consisting of water molecules that indirectly interact with the solute, through hydrogen bonding with the water molecules of the first layer. The distance from the solute to the second level is usually around 4.0 to 6.0 Å.

Subsequent levels tend to have distances to the solute that are less well defined, with water molecules hydrogen bonded to the adjacent inner level, and levels extending outwards in increments of about 2-3 Å per level.

In some embodiments of the composition, in a dry state, the sorbent in the presence of a gas stream will adsorb CO₂ through conversion of CO₂ to a carbonate anion, and, in a wetted state the sorbent releases CO₂. Subsequently, when subjected to drying, the capture layer reverts to the set of neutral ion pairs with a hydration shell when returned to the dry state. Without wishing to be bound by theory, it is believed that the proximity of water molecules in the hydration shell to the anion around which they are arranged promotes disassociation of water into H⁺ and OH⁻, thus facilitating reaction with CO₂ to form a carbonate anion (HCO₃⁻) and a protonated form of the anion in the hydration shell (in the terminology above, that protonated anion has the formula HA_{z}Oₓ^{(y-1)-}). Together, the carbonate anion and the protonated anion act as counterions to the cation of the ion modified material, thereby capturing CO₂ until the equilibrium reaction is reversed. When the sorbent material is in its ‘dry’ state ready for carbon capture, water molecules remaining in the material for a hydration shell around the ion pairs, leading to a high water concentration in the local environment immediately surrounding the ion pairs on the surface of the sorbent, the water molecules being held in place by hydrogen bonds between the water molecules and the anion of the ion pair. When exposed to CO₂, it can be that the increase in CO₂ concentration drives the equilibrium reaction forwards, favoring reaction of CO₂ with water to form carbonate anions. It is further believed that increasing water concentration at the surface of the sorbent (i.e. by wetting the sorbent material) destabilizes the hydration shell, as the presence of additional water molecules disrupt the hydrogen bonds between the hydration shell water molecules and the anions of the ion pairs. As a result, the local water concentration (i.e. the concentration of water molecules in the immediate vicinity of the ion pair) can reduce, driving the equilibrium backwards and thus favoring re-formation of CO₂.

Without wishing to be bound by theory, it is believed that, e.g. when the anion of the capture layer is carbonate, carbonate anions and water molecules in the hydration shell can be present in the following equilibrium:

CO₃²·nH₂O [symbol] HCO₃²⁻·m₁H₂O+HO⁻·m₂H₂O+(n-1-m₁-m₂)H₂O

That equilibrium releases hydroxide ions, which react with CO₂ to form bicarbonate in the reaction equilibria disclosed herein above. It will be appreciated that the amount of water in the equilibrium system controls the position of the equilibrium. It has been found that free energy of the forward reaction (i.e. generation of hydroxide) inverts from positive to negative when n is 10, with n values above 10 resulting in a positive free energy (according to which the equilibrium favors formation of carbonate) and with n values below 10 resulting in a negative free energy (according to which the equilibrium favors formation of bicarbonate and hydroxide). In the dry sorbent material, n is the water number, or number of water molecules per anion. Thus, by drying such a sorbent material to reduce n to 10, hydroxide ions are made available for reaction with CO₂ to form carbonate.

In some embodiments, the nanoporous oxide material comprises or is selected from a group of materials consisting of aluminum oxide (Al₂O₃) (also referred to as alumina), silicon oxide (SiO₂ ) (also referred to as silica), cerium oxide (CeO₂) (also referred to as ceria), zirconium oxide (ZrO₂) (also referred to as zirconia), iron oxide (FeOx, such as Fe₂O₃ and/or FeO), aluminosilicates, mesoporous oxide ceramics, and mixtures thereof.

In some embodiments, the oxide material comprises or is a combination of materials selected from a group consisting of aluminum oxide (Al₂O₃), silicon oxide (SiO₂ ), cerium oxide (CeO₂), zirconium oxide (ZrO₂), iron oxide (FeOx), and aluminosilicates, and mesoporous oxide ceramics.

In some embodiments, the at least one cation (e.g., positive charge ions of the ionic pair) comprises or is selected from a positive charge ion group (i.e., a cation group) consisting of Na⁺, K⁺, and polyatomic cations such as glycidyltrimethylammonium (GTA⁺), and wherein the at least one anion (e.g. a multivalent anion) (e.g., negative charge ions of the ionic pair) comprises or is selected from a negative charge ion group (i.e., an anion group) consisting of carbonate (CO₃²⁻), oxalate (C₂O₄²⁻), phosphate (PO₄³⁻), phosphite (PO₃²⁻), sulfite (SO₃²⁻), sulfate (SO⁴⁻), borate (BO₃³⁻), and silicate (SiO₄⁴⁻).

In some embodiments, the ionic pairs comprises of two polyatomic cations such as glycidyltrimethylammonium (GTA⁺) cations and an anion (e.g. a multivalent anion), such as an anion comprising or selected from a negative charge ion group (i.e., an anion group) consisting of carbonate (CO₃²⁻), oxalate (C₂O₄²⁻), phosphate (PO₄³⁻), phosphite (PO₃²⁻), sulfate (SO⁴⁻), sulfite (SO₃²⁻), borate (BO₃³⁻), and silicate (SiO₄⁴⁻).

In some embodiments, the set of neutral ionic pairs is a combination of neutral ionic pairs with different anions selected from the negative charge ion group.

In some embodiments, the at least one cation (e.g., positive charge ions of the ionic pair) comprises or is selected from a positive charge ion group (i.e., a cation group) consisting of Na⁺, K⁺, and a polyatomic cations such as glycidyltrimethylammonium (GTA⁺), and wherein the at least one anion (e.g. a multivalent anion) (e.g., negative charge ions of the ionic pair) comprises or is selected from a group of anions consisting of carbonate, oxalate, silicate, phosphate, phosphite, sulfate, sulfite, and borate.

It will be appreciated that a set of neutral ion pairs can comprise a mixture of cations and/or anions, for example wherein each individual pair is the same or different.

According to a fourth aspect of the disclosed subject matter, a method of preparing a sorbent composition for use in adsorption of a target gas from a gas stream is provided. Optionally, the method comprises forming a sorbent precursor by contacting a covalent network solid oxide substrate material with a linker precursor reactant, contacting sorbent precursor with an ionic compound comprising a metal from Group 1 or Group 2 of the period table and a multivalent anion, and, removing salt comprising the metal from Group 1 or Group 2 of the period table and the monovalent anion. Optionally, the linker precursor reactant comprises an anion and a polyatomic cation. Optionally, the polyatomic cation is selected from ammonium, phosphonium, arsonium, stibonium, bismuthium and sulfonium. Optionally, said contacting a covalent network solid oxide substrate material with a linker precursor reactant is performed under conditions effective to form a covalent bond between an oxygen atom on a surface of the substrate material and the polyatomic cation. Optionally, said contacting sorbent precursor with an ionic compound is performed under conditions effective to cause ion exchange, thereby exchanging the multivalent anion for the monovalent anion. Optionally, the method comprises forming a suspension of the covalent network solid oxide material in an aqueous solution (such as water), optionally adding the linker precursor reactant to the suspension to form an intermediate mixture, and optionally adding the ionic compound to the mixture of the suspension and the linker precursor reactant to form a product mixture. Optionally, the step of removing the salt comprises centrifuging the product mixture, optionally thereby separating a by-product solution comprising water and the salt from the sorbent composition. According to a fifth aspect of the disclosed subject matter, a method of preparing a sorbent precursor for a sorbent composition for use in adsorption of a target gas from a gas stream is disclosed. Optionally, the method of the fifth aspect forms the precursor sorbent formed by the method of the fourth aspect. Optionally, the method comprises contacting a covalent network solid oxide substrate material with a linker precursor reactant. Optionally, the linker precursor reactant comprises an anion and a polyatomic cation. Optionally, the polyatomic cation is selected from ammonium, phosphonium, arsonium, stibonium, bismuthium and sulfonium. Optionally, said contacting is performed under conditions effective to form a covalent bond between an oxygen atom on a surface of the substrate material and the polyatomic cation. Optionally, the method comprises forming a suspension of the covalent network solid oxide material in an aqueous solution (such as water), and adding the linker precursor reactant to the suspension to form a mixture comprising the precursor.

Optionally, such methods comprise subjecting the covalent network solid oxide material to ion exchange prior to contacting the covalent network solid oxide material with the linker precursor reactant. Optionally, the covalent network solid oxide material is subjected to ion exchange by suspending the covalent network solid oxide material in an aqueous solution (such as water) and contacting the suspension with an ion exchange resin. Optionally, the ion exchange resin is first cleansed by contact with deionized water, for example by running deionized water through the ion exchange resin until the water runs clear. Optionally, such methods comprise adding the ionic linker moiety in an amount providing a weight ratio of ionic linker to covalent network oxide solid material of about 1:5 to about 1:0.04, such as about 1:4 to about 1:0.06, the ratios being, for example, weights of each material in grams. Additionally or alternatively, such methods comprise adding the ionic linker moiety in an amount of about 80 to 160 mmol, for example about 100 to about 140 mmol, per gram of the covalent network solid oxide substrate material. Optionally, the substrate material is functionalized by reaction of each said oxygen on the surface of the substrate material with a carbon atom of a linker precursor reactant susceptible to nucleophilic attack, thereby forming the C—O covalent bond. Optionally, the linker precursor reactant comprises a cation selected from N-[3-(Trimethoxysilyl)propyl]-N, N,N-trimethylammonium, N-(Trimethoxysilylpropyl)-N,N,N-trimethylphosphonium and glycidyltrimethylammonium. Optionally, the substrate material is functionalized by reaction of each said oxygen on the surface of the substrate material with an epoxide group of a linker precursor reactant, thereby forming the C—O covalent bond. Optionally, the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond. Optionally, the target gas is CO₂.

Optionally the sorbent composition, sorbent precursor, polyatomic cation, ionic compound (if present) and/or salt (if present) is as defined as disclosed in relation to the sorbent material of the first or third aspect of the disclosure, and/or in relation to the sorbent precursor of the second aspect of the disclosure.

According to a sixth aspect of the disclosed subject matter, a method for production of a carbon dioxide sorbent is disclosed. The method can include supplying a sorbent carrier layer that is made of an oxide material; and reacting an ion-functional group with a carrier layer to form a capture layer, the ion functional group having at least one carbon dioxide adsorption site.

In some embodiments, supplying the sorbent carrier layer includes providing an oxide material suspension in a solution; and wherein reacting the ion-functional group to the carrier layer as the capture layer includes: running the oxide material suspension through a cation exchange resin, performing an ion exchange by adding the cation exchange resin to the solution, mixing glycidyltrimethylammonium chloride to the solution, and mixing anions to the solution.

In some embodiments, the oxide material suspension is in water, and about 5%w.t. is added to the solution.

In some embodiments, performing the ion exchange includes adding the cation exchange resin to the solution at least four times.

In some embodiments, about 6 mmol glycidyltrimethylammonium chloride is mixed to the solution for every 1 gram of the solution of 5 wt. % oxide suspension.

In some embodiments, the oxide material suspension comprises or is selected from a group of materials consisting of aluminum oxide (A12O3), silicon oxide (SiO₂ ), cerium oxide (CeO₂), zirconium oxide (ZrO₂), iron oxide (FeOx), aluminosilicates, mesoporous oxide ceramics, and mixtures thereof.

In some embodiments, the oxide material suspension comprises or is a combination of materials selected from a group consisting of aluminum oxide (Al₂O₃), silicon oxide (SiO₂ ), cerium oxide (CeO₂), zirconium oxide (ZrO₂), iron oxide (FeOx), aluminosilicates, and mesoporous oxide ceramics.

In some embodiments, the anions comprise or are selected from a group consisting of carbonate, oxalate, phosphate, phosphite, sulfate, sulfite, sulfate, and borate.

In some embodiments, the anions originate from an ionic material, such as an alkali metal salt. Examples of alkali metal salts include sodium phosphate, sodium sulfite, sodium borate, and sodium carbonate.

It will be understood that the method of the sixth aspect of the disclosed subject matter can optionally incorporate any feature described in relation to the methods of the fourth or fifth aspects of the disclosed subject matter, and vice versa.

According to a seventh aspect of the disclosed subject matter, a method of removing a target gas from a gas stream is provided. Optionally, the gas stream has a first concentration of target gas. Optionally, the method comprises contacting the gas stream with a sorbent composition under conditions effective to cause adsorption of the target gas by the sorbent, for example thereby forming a target gas enriched sorbent composition and a product gas stream having a second target gas concentration, for example wherein the second target gas concentration is lower than the first target gas concentration. According to an eighth aspect of the disclosed subject matter, a method of removing a target gas from a target gas enriched sorbent composition is provided. Optionally, the method comprises contacting the target gas enriched sorbent composition with a gas stream and water. Optionally, the water is a component of the gas stream, for example wherein the gas stream comprises water vapor. Optionally, said gas stream has a relative humidity of at least 80%, such as at least 90%, for example at least 99%.

Optionally, the gas stream has a first concentration of target gas. Optionally, the method comprises contacting the gas stream with the target gas enriched sorbent composition under conditions effective to cause desorption of the target gas from the sorbent, for example thereby forming a wetted sorbent composition and a product stream (such as a product gas stream) having a second target gas concentration, for example wherein the second target gas concentration is higher than the first target gas concentration. Optionally, the method comprises separating the target gas from the product stream, and optionally treating the target gas to provide a target gas product suitable for use and/or storage.

Optionally, in such methods according to the seventh and/or eighth aspects of the disclosure, the sorbent composition comprises a covalent network solid oxide substrate material functionalized with an ionic linker moiety. Optionally, each ionic linker moiety comprises a multivalent anion, and a polyatomic cation, such as a polyatomic cation selected from ammonium, phosphonium, arsonium, stibonium, bismuthium and sulfonium. Optionally, the polyatomic cation is connected to an oxygen atom on a surface of the substrate material by a covalent bond. Optionally, the target gas is CO₂. Optionally, the sorbent composition is as disclosed according to the first or third aspects of the disclosed subject matter.

Optionally, the method of the eighth aspect of the disclosed subject matter (i.e. the method of removing a target gas from a target gas enriched sorbent composition) further comprises a step of drying the wetted sorbent composition to form a sorbent composition.

Optionally, the drying step is performed once substantially all target gas is desorbed from the sorbent material, and/or once the product gas stream produced by contacting the wetted sorbent material with the gas stream has a target gas concentration about the same as the target gas concentration of said gas stream. It will be appreciated that in such a scenario, no further target gas is extracted from the sorbent by continued exposure to the gas stream. Optionally, such drying comprises exposing the wetted sorbent composition to a gas stream with a lower water content than the water content of the gas stream utilized for wetting the sorbent composition.

Optionally, the wetted sorbent composition is dried by contact with a gas stream having a relative humidity of no more than about 60 %, such as no more than about 50%, for example no more than about 45%. Optionally, the step of drying the sorbent composition produces a sorbent composition according to the first or third aspect of the disclosed subject matter. Additionally or alternatively, the step of drying the sorbent optionally provides a dried sorbent composition comprising water, wherein the dried sorbent composition comprises water in an amount less than an amount of water in the wetted sorbent composition. Optionally, the dried sorbent composition comprises water, wherein water is present in a molar ratio of water: multivalent anion of from 1:10 to 40:1, such as 1:1 to 1:20.

According to a ninth aspect of the disclosed subject matter, a method of treating a gas stream is provided. Optionally, the method comprises performing the method of the seventh aspect of the disclosed subject matter, and subsequently performing the method of the eighth aspect of the disclosed subject matter. Optionally, the method comprises performing the drying step of the method of the eighth aspect of the disclosed subject matter, and subsequently repeating the method of the seventh aspect of the disclosed subject matter. Optionally, the method of the seventh aspect of the disclosed subject matter is so repeated at least 5 times, such as at least 50 times, for example at least 500 times. Additionally or alternatively, the method comprises reusing the sorbent composition so formed by drying, optionally without any further treatment or regeneration of the dried sorbent composition.

According to a tenth aspect of the disclosed subject matter, a method for capture of carbon dioxide is disclosed. The method including providing a humidity swing sorbent, the humidity swing sorbent being a material that includes: a sorbent carrier layer that is made of a material comprising or selected from a group consisting of oxide nanoparticles and nanoporous materials, and a capture layer, the capture layer including an ion-modified material having at least one carbon dioxide adsorption site; exposing the humidity swing sorbent to a target gas; and wetting the humidity swing sorbent.

In some embodiments, wetting the humidity swing sorbent includes collecting output water, which comprises released target gas.

In some embodiments, the method including processing output water for capturing of the target gas.

In some embodiments, the target gas is carbon dioxide.

In some embodiments, the method includes drying the humidity swing sorbent and reusing the humidity swing sorbent for subsequent exposure to the target gas.

It will be appreciated that the method of the tenth aspect of the disclosed subject matter can incorporate any feature described in relation to the methods of the seventh, eighth or ninth aspects of the disclosed subject matter, and vice versa.

According to an eleventh aspect of the disclosed subject matter, a porous membrane for use in apparatus for separating a target gas from a gas stream is provided. Optionally, the porous membrane comprises a sorbent composition as disclosed in the first or third aspect of the disclosed subject matter. Optionally, the target gas is CO₂. Optionally, the porous membrane contains the sorbent composition. Optionally, the porous membrane consists of the sorbent composition, for example wherein the sorbent composition is in the form of a porous material through which a gas comprising the target can be passed. Alternatively, the porous membrane optionally comprises the sorbent composition supported on a membrane material, such as a polymeric membrane material, for example wherein the sorbent composition is incorporated into a porous membrane material.

According to a twelfth aspect of the disclosed subject matter, apparatus for separation of a target gas from a gas stream is provided. Optionally, the apparatus comprises a sorbent composition as disclosed according to the first or third aspect of the disclosed subject matter. Optionally, the sorbent composition is arranged for contact with the gas stream. For example, it can be that the sorbent composition is provided in a channel configured to receive a gas stream comprising the target gas. Optionally, the target gas is CO₂. Optionally, the apparatus comprises the porous membrane of the eleventh aspect of the disclosed subject matter, for example wherein the porous membrane comprises or consists of the sorbent material. Optionally, the apparatus comprises air moving devices, such as fans, for effecting contact of the gas stream with the sorbent composition (for example for transporting the gas stream along or through a channel in which the sorbent material is located). Optionally, the apparatus comprises a wetting device for wetting the sorbent material, such as a sprayer, mister or evaporator. Optionally, the wetting device adds moisture to a gas stream for contact with the sorbent material. Additionally or alternatively, it can be that the wetting device sprays or otherwise deposits water directly on the sorbent material. Optionally, the apparatus comprises a heater, for example to aid drying of the sorbent material. Optionally, such a heater is configured to heat a gas stream for contact with the sorbent material, and/or to directly heat the absorbent material, e.g. by radiation or conduction of heat. Alternatively, the apparatus is free from a heating device, for example wherein the apparatus is configured to dry the sorbent material by contact with an ambient temperature gas stream having a suitable humidity.

### BRIEF DESCRIPTION OF DRAWINGS

FIG. 1 is a diagram of adsorption and desorption timeline of a prior polymer resin-based sorbent.

FIG. 2 shows an image of a ceramic oxide particulate material, and TEM images of said particulate material, according to some variations of the present disclosure.

FIG. 3 is a diagram of CO₂ adsorption and desorption performance of an oxide-based humidity swing sorbent according to some variations of the present disclosure.

FIG. 4 is a diagram of five cycles of CO₂ capture and desorption by an oxide-based humidity swing sorbent according to some variations of the present disclosure.

FIG. 5 is a schematic representation of an exemplary system operated in a CO₂ capture mode, a desorption mode, and a restoring mode.

FIG. 6, FIG. 7, and FIG. 8 are flow diagrams of method variations for producing a humidity swing sorbent.

FIG. 9, FIG. 10, FIG. 11, and FIG. 12 are flow diagrams of method variations for capturing CO₂ using a humidity swing sorbent.

FIG. 13 is a diagram representation of a humidity swing sorbent variation with an oxide nanoparticle carrier layer with a capture layer of ion-modified materials bonded around a surface of the oxide nanoparticle.

FIG. 14 is a diagram representation of a humidity swing sorbent variation with a nanoporous carrier layer that contains ion-modified materials of a capture layer within the pores.

FIG. 15 and FIG. 16 are charts of energy comparisons of humidity swing sorbent variations to other capture technologies.

FIG. 17A is a schematic diagram illustrating adsorption of carbon dioxide in connection with a hydration ring around an anion in dry conditions according to some variations of the present disclosure.

FIG. 17B is a schematic diagram illustrating desorption of carbon dioxide in connection with breakdown of a hydration ring around an anion in wet conditions according to some variations of the present disclosure.

FIG. 18 is a schematic representation of ionic pairs graphed onto an oxide nanoparticle with spacing of anions suitable for formation of a hydration shell according to some variations of the present disclosure.

FIG. 19 is a schematic representation of ionic pairs contained within a pore of a nano/mesoporous with spacing of anions suitable for formation of a hydration shell according to some variations of the present disclosure.

### DETAILED DESCRIPTION OF THE EMBODIMENTS

The following description of the embodiments of the present application is not intended to limit the disclosed subject matter to these embodiments but rather to enable a person skilled in the art to make and use the disclosed subject matter.

### 1. Overview

The compositions, methods, and systems for a humidity swing sorbent described herein use an ion-functionalized material to capture and controllably release select target gases.

In particular, the compositions, methods, and systems described herein can be used for the capture of carbon dioxide (CO₂ ) from the air and then controlled release using a humidity swing. The compositions, methods, and systems can alternatively or additionally be used for the capture and release of target gases such as sulfur dioxide (SO₂), hydrogen sulfide (H₂S), and nitrogen oxides (NOx such as nitrogen monoxide NO and nitrogen dioxide NO₂). Herein, the humidity swing sorbent can be primarily described in the context of CO₂ capture and release and using examples for the capture and release of CO₂, but the compositions, methods, and systems are not limited to only CO₂ and be similarly adapted for capture of other target gases.

The humidity swing sorbent is preferably an ion-functionalized material, which in some variations can in some variations be made using a nanoparticle carrier layer or a carrier layer with a nanoporous/mesoporous structure. The humidity swing sorbent uses a carrier layer to serve as a structural framework on which a capture layer made with an ion assembly-more specifically an ionic pairing (e.g., grouping of cation(s) and anion(s) of some ratio, which can be neutrally charged overall)-can be arranged in space to facilitate chemically capture and release carbon dioxide through humidity swing. The ionic pairs can be spatially distributed using scaffolding of the carrier layer so that the ionic pairs and more specifically the anions of the ionic pairs are suitably spaced for formation of a hydration shell around each anion. Described another way, the anions can be spaced in a non-crystalline spacing which can be characterized herein by anions being spaced with a distance greater than the diameter of a hydration shell. Spacing of anions can also be referred to as displacement, for example. In some variations, a hydration shell can have one to three levels. In some variations, the displacement can be greater than some displacement ranging from 1-15 angstroms (Å). In a one-level hydration shell, the displacement between anions (e.g., of different ionic pairs) can be greater than 2-3 angstroms (Å). In a two-level hydration shell, the displacement between anions (e.g., of different ionic pairs) can be greater than 3-5 angstroms (Å). In a three-level hydration shell, displacement between anions (e.g., of different ionic pairs) can be greater than 10-15 angstroms (Å).

For example, by binding or grafting around a nanoparticle, anions can be spaced so to allow CO₂ to interact with the sorbent through interactions with the hydration shell. The spacing will be such that CO₂ can react to form a bicarbonate captured within the hydration shell. However, when the number of water molecules reaches a certain level (e.g., greater than 10-40 water molecules), then conditions break down causing the bicarbonate to revert and releasing resulting CO₂ into the aqueous solution (e.g., water). When the sorbent is returned to a dry condition, a hydration shell can reform around the anions so that CO₂ can once again be captured.

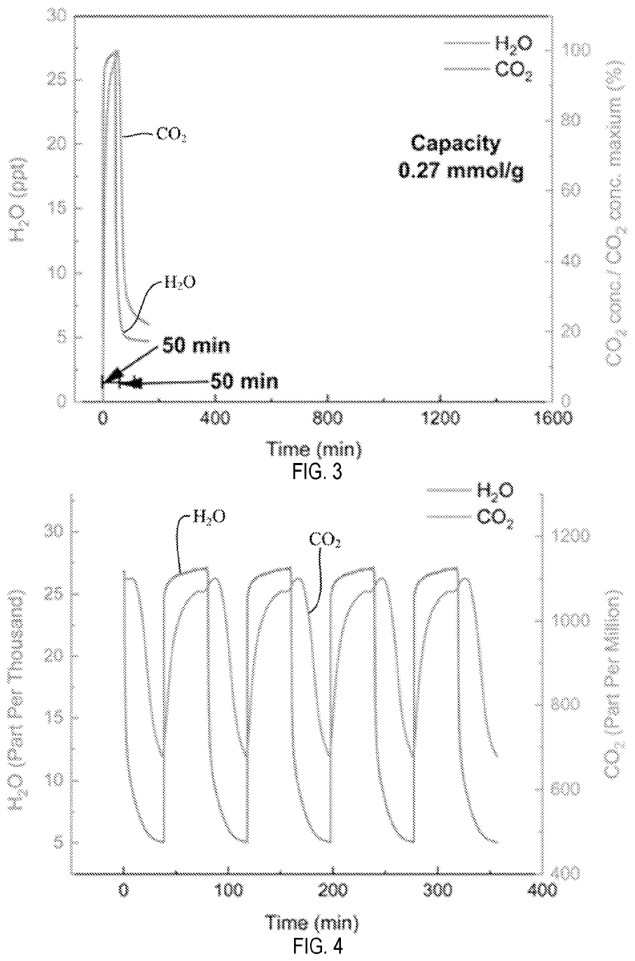

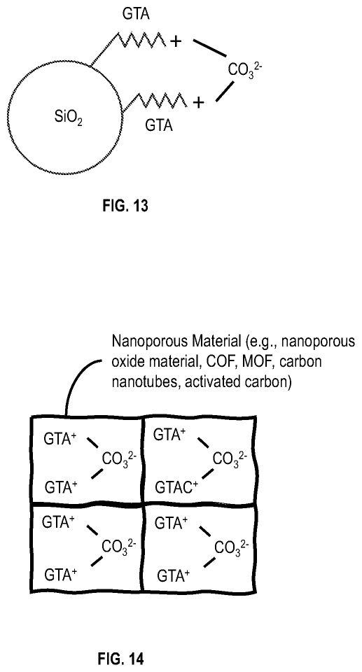

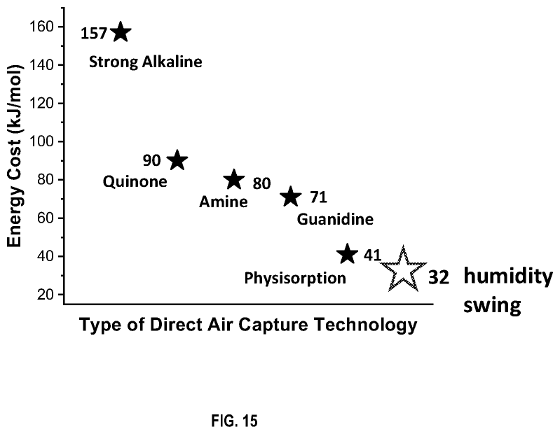

The carrier layer materials used within the sorbent, including nanoparticle and/or nanoporous materials, can enable a large surface area and structure that can provide enhanced channels for CO₂ and H₂O transfer. In one variation, oxide-based nanoparticles can be used as a carrier layer with the capture layer bonding around the oxide nanoparticle as shown in FIG. 13. Additionally, nanoparticles (NPs, diameter of 1-1000 nm) can have fully exposed surfaces with extremely high surface area. Additionally, the nanoparticles can be used a scaffold on which cations of ionic pairs can be grafted or otherwise bind to enforce geometric spacing of the anions suitable to form a hydration shell around the anions. FIG. 2 shows TEM images of the ceramic material according to some embodiments of the present disclosure. In other variations, the carrier layer can be a nanoporous material (e.g., pores sized 1-1000 nm) and in some cases a mesoporous material (e.g., pores sized 2 and 50 nm). In a carrier layer made of nanoporous/mesoporous material, ion-modified material of a capture layer can be contained within the pores of the porous material as shown exemplary diagram of FIG. 14.

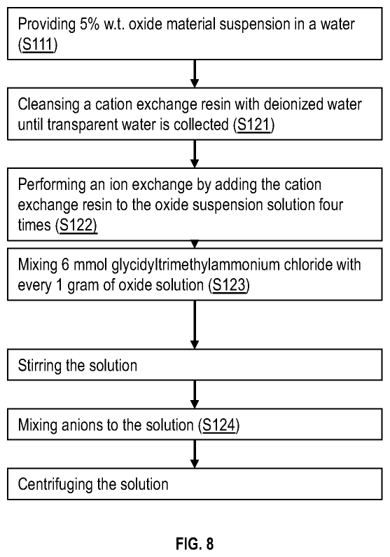

The compositions, methods, and systems can use the humidity swing sorbent in various direct air capture applications. The humidity swing ion-functionalized materials within the humidity swing sorbent can be used to capture CO₂ (and other acid gases) from the air in a dry condition and release CO₂ in wet conditions (humidity swing) as shown in FIG. 5. In dry conditions, a hydration shell forms around anions of ionic pairs (which are spatially arranged through scaffolding of some carrier layer). Carbon dioxide exposed to the anions and the hydration shell will result in a reaction with formation of bicarbonate (HCO₃⁻). In some embodiments, the loaded sorbent can be regenerated by washing it with water. Introducing a large number of water molecules causes water to act as bulk water molecules. As such, when the number of water molecules becomes sufficiently large in proximity to the ionic pair (such as >10, >20, >30, >40, or even >50), the hydration shell can break down. Breaking down the hydration shell causes carbon dioxide that has been chemically captured (in the form of a bicarbonate) to be released. In some embodiments, the sorbent can be dried in the air so it can take up target gases again. When dried, a hydration shell can reform around the ionic pairs and then capture CO₂ again.

The capture or release process of the sorbent can be driven by inexpensive water. When there is less humidity in the air, the sorbent can capture CO₂. When the sorbent is partially or fully loaded, the sorbent can be placed into water (or another wetting solution), and the CO₂ is released. The released CO₂ can be collected or processed. For example, the CO₂ can be prepared for storage or used in other applications. In one example, collected CO₂ can be used in greenhouses, the cement industry, flower/fruit transportation, synthetic fuel production, and/or other applications.

The system and method can provide a number of potential benefits. The system and method are not limited to always providing such benefits and are presented only as exemplary representations for how the system and method can be put to use. The list of benefits is not intended to be exhaustive and other benefits can additionally or alternatively exist.

As one potential benefit, the compositions, methods, and systems can provide a sorbent that is particularly well suited for direct air capture applications. Some preferred variations of the sorbent can capture CO₂ directly from the ambient air. Additionally, the sorbent can be highly selective. In particular, some variations of the sorbent can only capture CO₂, not H₂O from the air.

As another benefit, the compositions, methods, and systems use a humidity swing sorbent that uses a chemical reaction to capture carbon dioxide. Introduction of water to the sorbent reverses the chemical reaction bonding carbon dioxide to the sorbent. The compositions, method, and systems use can avoid issues encountered with sorbents that use physical adsorption. For example, the humidity swing sorbent can avoid the simultaneous, excessive capture of water, which happens in many other sorbents. In particular, systems utilizing long-chain amines (such as polyethyleneimine, PEI) have a tendence to adsorb large quantities of water. In contrast, some variations of the present disclosure use oxide materials as a structural framework to achieve a scaffold with desired surface area to expose an ion-modified material of a capture layer.

As another potential benefit, the compositions, methods, and systems can use a sorbent that exhibits remarkable stability. In some variations, the humidity swing sorbent experiences minimal or no degradation after 10,000 cycles.

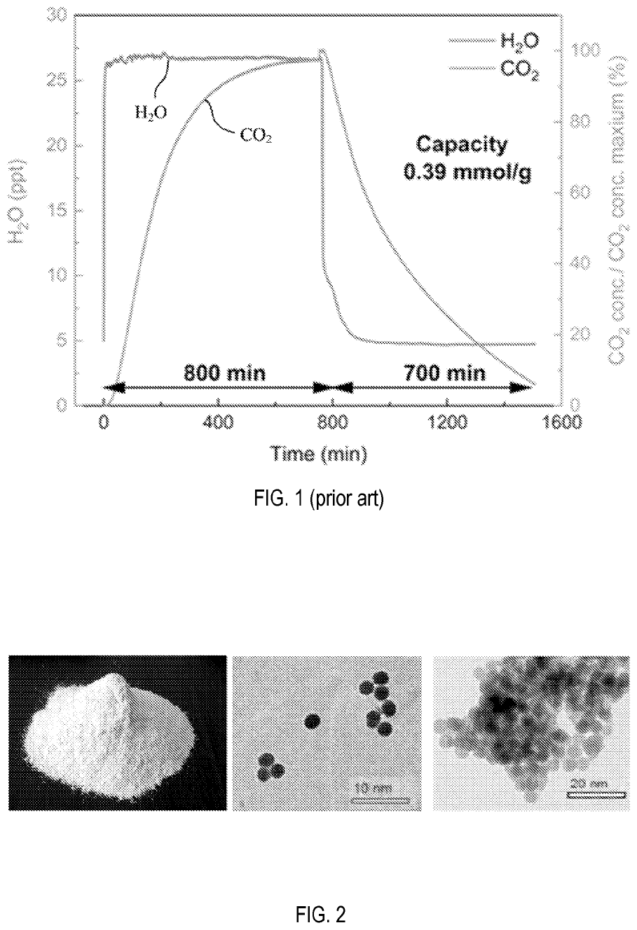

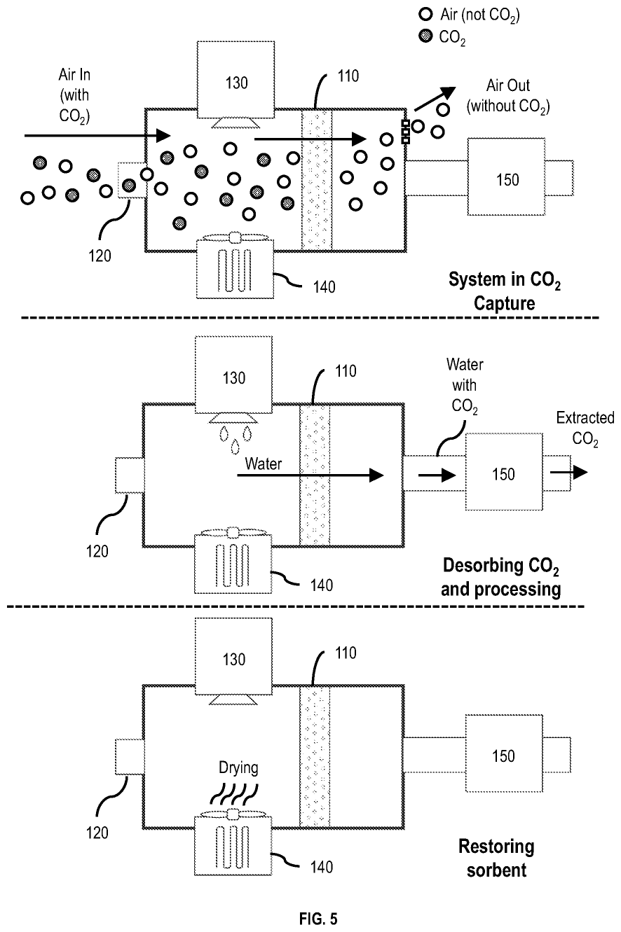

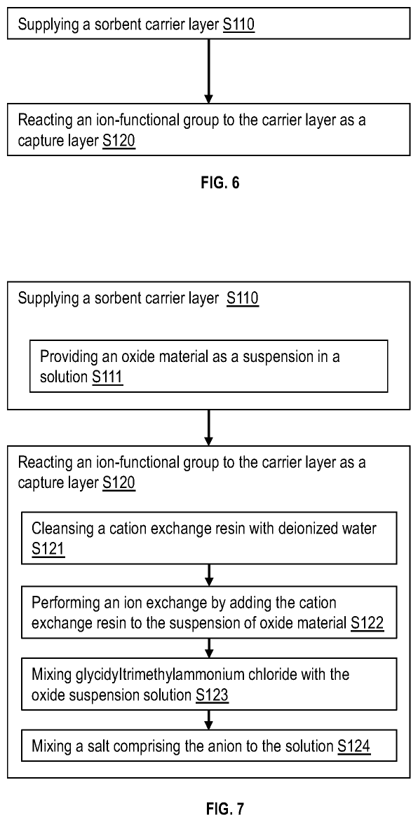

As another potential benefit, the compositions, methods, and systems can enable fast kinematics during the capture and release of target gases such as CO₂. As shown in exemplary data of FIG. 1 for previous resin-based humidity swing sorbents, adsorption and desorption time frame of prior polymer-based resign sorbent material could take over ten hours. Accordingly, the material limitations of such resins posed serious limitations to practical viability of such a solution. As shown in FIG. 3, the sorbent material of a variation described herein can exhibit significantly faster adsorption and desorption time frame of less than an hour in some cases (e.g., approximately 50 minutes in the experimental example shown in FIG. 3). Accordingly, this can mean that the humidity swing sorbent could be cycled many more times in a given time period. For example, FIG. 4 shows five cycles of CO, capture and release by a sorbent variation described herein.

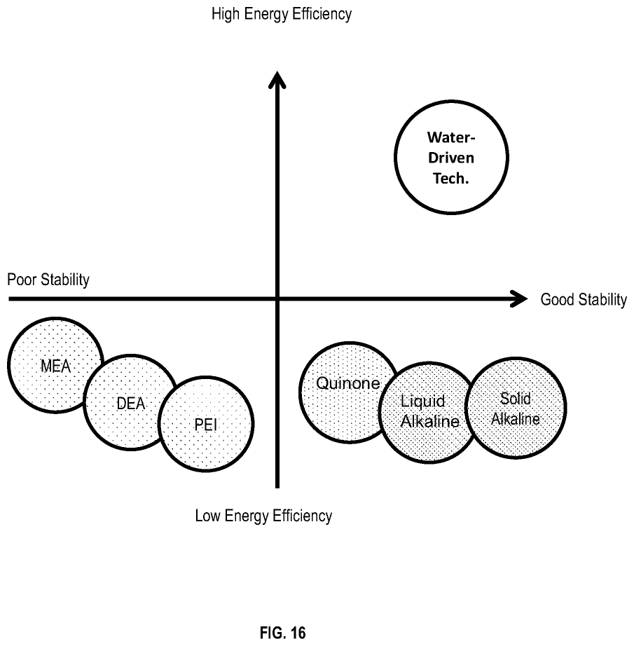

As one potential benefit, the compositions, methods, and systems can enable a highly energy efficient solution for capture of target gasses such as CO₂. The humidity swing sorbent described herein can have sorption energy costs in some instances being a fraction (e.g., 35% or less) of other comparable existing sorbents. As shown in FIG. 15 and FIG. 16, the water-driven humidity swing sorbents described herein can exhibit high energy efficiency and good stability compared to competing technologies. Furthermore, in addition to its high energy efficiency, the humidity swing sorbent cannot consume heat during regeneration, which is considered a significant bottleneck for the high energy cost of traditional direct air capture technologies.

Compared to traditional amine solutions, the energy cost can be a third or less (e.g., less than or equal to 33%) of the energy cost. Compared to traditional strong alkaline solutions, the energy cost can be a sixth or less (e.g., less than or equal to approximately 17%) of the energy cost.

For example, a Ca-based calcination process and Na-based decomposition and hydrolysis process have a heat of adsorption of 179 KJ/mol of CO₂ and 135 KJ/mol of CO₂, respectively. The average value of reported heat of sorption of amine-based sorbents was estimated at around 80 KJ/mol to 120 kJ/mol of CO₂, based on the average value of reported heat of sorption of CO₂ by amine solution. In comparison, humidity swing sorbents of the present disclosure can exhibit an energy cost of 32 kJ/mol of CO₂ for sorbent regeneration. Optionally, the sorbent composition of the disclosed subject matter provides a carbon capture system with an energy usage of no more than about 50 KJ/mol of CO₂ captured, such as no more than about 40 KJ/mol of CO₂ captured.

As another potential benefit, the compositions, methods, and systems can serve as a cost-effective solution from a monetary perspective. Both capital expenditure and operational expenditure can be cost effective. In some implementations, the cost for captured CO₂ can be less than $100 per ton of CO₂. As one contributing factor to the solution's cost effective benefit, the humidity swing CO₂ sorbent uses inexpensive water, and does not require added heat. As another contributing factor, the stability of the sorbent also contributes to reduced operational costs.

As another potential benefit, the compositions, methods, and systems have a design that makes it a scalable solution, enabling the compositions, methods, and systems to be scaled to massively large scales while remaining cost effective. Such scalability is vitally important for being an effective solution for the world's environmental problems.

### 2. Composition

A composition for a sorbent can include: a sorbent carrier layer; and a capture layer, the capture layer comprising an ion-modified material. The ion-modified material preferably has at least one target gas adsorption site thereon. Such a composition can be used as a sorbent used for the adsorption of a target gas. In particular, such a composition or a variation described herein can be used for adsorption of carbon dioxide but can additionally or alternatively be used for other target gasses such as SO₂, H₂S, and NOx.

Accordingly, in some variations, the adsorption site can be a carbon dioxide adsorption site. In this way, the sorbent enables a humidity swing chemical reaction wherein, in a dry state, the sorbent in the presence of a gas stream with will adsorb CO₂ through conversion of CO₂ to bicarbonate, and, in a wetted state the sorbent releases CO₂ and the capture layer reverts back to the ion-modified material when returned to a dry state. In some alternative variations, the adsorption site(s) can be a sulfur dioxide adsorption site, a hydrogen sulfide adsorption site, or a nitrogen oxide adsorption site. Herein, the composition is primarily described in the context of capturing CO₂, but the composition can alternatively be altered and/or used for capturing other target gases.

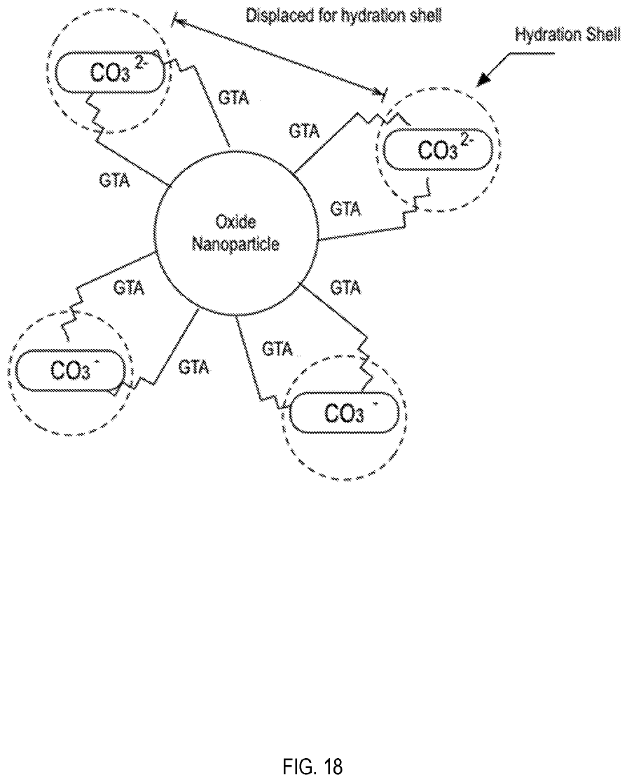

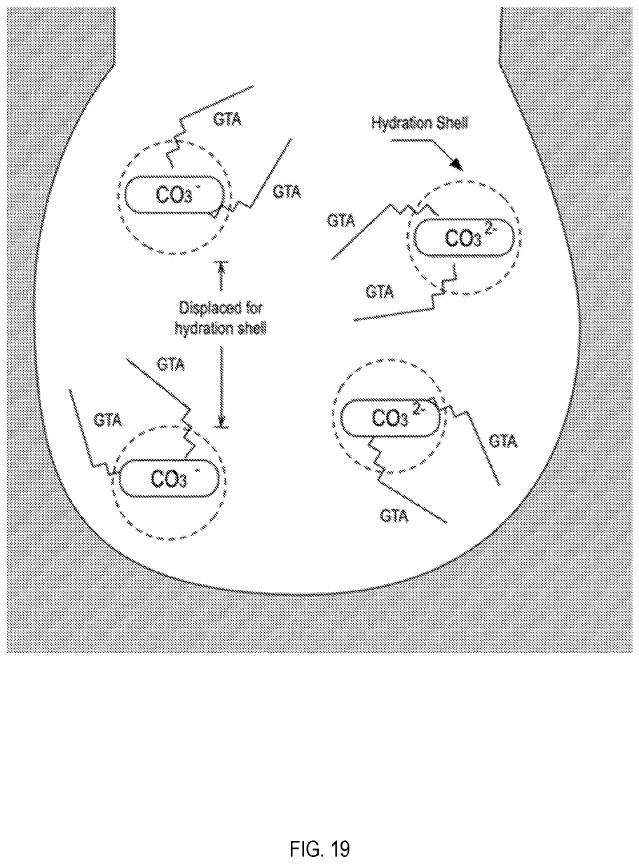

The ion-modified material is preferably a combination of positive charge ions (cations) and negative charge ions (anions). The positive charge ions and negative charge ions are preferably implemented as ionic pairs. The ionic pairs can be a neutrally balanced combination of at least one cation and at least one anion. For example, one neutral ionic pair can be two glycidyltrimethylammonium (GTA⁺) cations and one carbonate ion (CO₃²⁻). The anions of the ionic pair can facilitate chemical bonding with carbon dioxide in dry conditions. This chemical bonding reaction that results in adsorption of carbon dioxide can occur when the number of water molecules are sufficiently low in proximity to the anions of the spaced ionic pair (e.g., in dry conditions). CO₂ can be released during exposure to wetted conditions (e.g., exposure to water). This capture and release can result from interaction with a hydration shell formed around anions spatially isolated in the structure of the sorbent. The anions can be spatially isolated (e.g., spaced sufficiently apart) because the ionic pairs bonded or grafted onto nanoparticles in a spaced arrangement as shown in FIG. 18 or through containment of the ionic pairs in pores of a nanoporous material as shown in FIG. 19.

As one variation, the carrier layer can use a carrier layer made of an oxide material as a scaffold for the capture layer. In such an oxide variation, a composition for a sorbent used for adsorption of carbon dioxide can include: a sorbent carrier layer that is made of an oxide material; and a capture layer, the capture layer comprising an ion-modified material having at least one carbon dioxide adsorption site thereon.

More specifically, in some variations, a composition for a sorbent used for adsorption of carbon dioxide can include: a sorbent carrier layer that is made of an oxide material; and a capture layer, the capture layer comprising a set of neutral ionic pairs with at least one cation and at least one anion, wherein the set of neutral ionic pairs are spatially distributed through scaffolding of the oxide material such that the anions of each neutral ionic pair are spaced for formation of a hydration shell around each anion, wherein the hydration shell around the anion is a carbon dioxide adsorption site.

The oxide variation of the sorbent can include nanoparticle variations and nanoporous variations of the sorbent.

In a nanoparticle variation, the carrier layer is made of an oxide nanoparticle material, wherein the ion-modified material is bonded around a surface of a nanoparticle of the oxide nanoparticle material. In a variation with a nanoparticle material carrier layer, the set of neutral ionic pairs that are spatially distributed on the scaffolding of the oxide material can be spaced by each cation of the at least one cation being grafted spatially on an oxide nanoparticle of the oxide nanoparticle material. The cations will be grafted or otherwise bonded around the oxide nanoparticle and the anion will bond to the cation. The arrangement of cations grafted onto the nanoparticle will enforce spaced separation of the anions of the ionic pairs. It will be appreciated that spacing of cations can be achieved, for example, by control of concentration of the cations in a solution with which the oxide material is treated. For example, the cations can have a tendency to avoid grafting onto the oxide material at sites in close proximity to each other, thus favoring greater spacing between cations at lower cation concentrations in solution.

Accordingly, in some variations, a composition for a sorbent used for adsorption of carbon dioxide can include: a sorbent carrier layer that is made of an oxide material; and a capture layer, the capture layer comprising a set of neutral ionic pairs with at least one cation and at least one anion, wherein each cation of the at least one cation of the set of ionic pairs is grafted spatially onto an oxide nanoparticle of the oxide nanoparticle material, such that the anions of each neutral ionic pair are spaced for formation of a hydration shell around each anion, wherein the hydration shell around the anion is a carbon dioxide adsorption site.

There can be multiple neutral ionic pairs that are grafted onto the same nanoparticle of the oxide nanoparticle material. The neutral ionic pairs are preferably grafted spatially onto or about the oxide nanoparticles such that anions of the neutral ionic pairs are sufficiently spaced. In some variations, the spacing between anions can be characterized as being non-crystalline spacing, wherein the anions do not behave as anions in a crystalized form. In this way, the anions can be suitable sites for formation of a hydration shell. The spacing between anions can be greater than the diameter of a hydration shell to allow space for formation of the hydration shell.

The oxide variation of the sorbent can also include a nanoporous or more specifically a mesoporous oxide material. In a nanoporous/mesoporous variation, the ion-modified material of the capture layer can be contained in pores of the nanoporous oxide material.

As another variation, the carrier layer can be made of a nanoporous material which can be made of oxide materials and/or other non-oxide nanomaterials. In such a porous variation, a composition for a sorbent used for adsorption of carbon dioxide can include a sorbent carrier layer that is made of a nanoporous material; and a capture layer, the capture layer comprising an ion-modified material having at least one carbon dioxide adsorption site thereon, and the ion-modified material being contained in pores of the nanoporous material.

More specifically, a composition for a sorbent used for adsorption of carbon dioxide can include a sorbent carrier layer that is made of a nanoporous material; and a capture layer, the capture layer comprising a set of neutral ionic pairs with at least one cation and at least one anion, wherein the set of neutral ionic pairs are contained in pores of the oxide nanoporous material such that the anions of each neutral ionic pair are spaced for formation of a hydration shell around each anion, wherein the hydration shell around the anion is a target gas (e.g. carbon dioxide) adsorption site.

The ionic pairs are preferably physically contained and isolated within individual pores. The number of ionic pairs that are present in each pore can be conditioned to result in the anions of different ionic pairs to be sufficiently spaced apart. It will be understood that such conditioning can, for example, be achieved by controlling concentration of ionic functionalization material when the carrier layer is treated with a solution of ionic functionalization material.

In a similar manner to the nanoparticle variation, the carrier layer serves as a scaffold to promote conditions for anions to be separated so that a hydration shell can form. In some variations, the neutral ionic pairs contained in the pores of the oxide nanoporous material have non-crystalline spacing of anions for hydration shell formation when there are less than 20 anions in a pore. However, the number of anions in each pore can be dependent in part on pore size.

Herein, the carrier layer is described as a nanoporous material having pores. The pores can be substantially spherical in form but can alternatively be tubes, non-regular pores, or have any suitable shape. The pores preferably have some limiting dimension at the nano scale which can help limit concentration of the ionic pairs, which can encourage formation of a hydration shell. For example, pore openings preferably have a maximum diameter of no more than about 15 angstroms, such as no more than about 12 angstroms. Additionally or alternatively, pore openings preferably have a maximum diameter of about 8 to 15 angstroms, such as about 10 to 12 angstroms.

In such nanoporous variations, the carrier layer can be or include a nanoporous material such as an oxide nanoporous materials and various other nanoporous materials.

Accordingly, the carrier layer can be a nanoporous material such as aluminum oxide (Al₂O₃), silicon oxide (SiO₂ ), cerium oxide (CeO₂), zirconium oxide (ZrO₂), iron oxide (FeOx), aluminosilicates, mesoporous ceramics, activated carbon, quartz, zeolite, carbon nanotubes, organometallic frame material (MOF), and/or covalent organic frame (COF) material.

The carrier layer functions as a structural scaffold for the ion-modified material of the capture layer. The carrier layer can provide a structural base so that ionic pairs have spacing suitable for formation of a hydration shell, and also to enhance exposure to a gas so as to chemically capture a target gas like carbon dioxide (e.g. by providing a high surface area).

The carrier layer can include structural features to the material and its formation that enhance exposure to a target gas. Accordingly, in some variations, the carrier layer can be made of a material that has a nanoporous or more specifically a mesoporous structure. In some alternative variations, the carrier layer can be made of a nanoparticle material.

In some variations, ceramic materials, including nanoporous/mesoporous materials, and oxide nanoparticles, can exhibit scaffolding structure enabling a large surface area for exposure. This type of material structure within the carrier layer can provide enhanced channels for CO₂ and H₂O transfer. Air (e.g., air for direct air capture or industrial gas streams) can preferably be exposed to a surface area of a sorbent with such carrier layers. Water can similarly make contact with large surface areas of a sorbent during desorption of carbon dioxide.

Variations using nanoparticles (NPs), which can have diameters of 1-1000 nm, can similarly have highly exposed surfaces with extremely high surface area. Such structural qualities can have beneficial benefits to the kinematics of the sorbent when used as a humidity swing sorbent.

As mentioned, in one variation, the carrier layer can be made of or include an oxide material. An oxide material carrier layer can be used as a nanoporous/mesoporous oxide material or as an oxide nanoparticle material. As a porous material, the ion-modified material more specifically the ionic pairs can be contained in pores of the nanoporous/mesoporous oxide material as shown in FIG. 19. In another variation, the oxide material carrier can be an oxide nanoparticle, wherein the sorbent is a collection of such nanoparticles. In a nanoparticle variation, the carrier layer includes a collection of oxide nanoparticles, and the ion-modified material (more specifically the ionic pairs) can be bound around the surfaces of the oxide nanoparticles as shown in FIG. 18. Oxide materials can be materials to which cations of the ion-modified materials can easily attach or graft.

In some variations the oxide material can be a ceramic material. It will be understood that a ceramic material can be an inorganic non-metallic solid that has been shaped and then hardened (and/or densified) by heating to high temperatures. Often, ceramic materials are characterized by being hard, corrosion-resistant, chemically non-reactive and brittle. Ceramic materials can be crystalline, glassy or both crystalline and glassy. In some variations, the oxide material can be an oxide material such as aluminum oxide (Al₂O₃), silicon oxide (SiO₂ ), cerium oxide (CeO₂), zirconium oxide (ZrO₂), iron oxide (FeOx), and/or an aluminosilicate. Accordingly, the oxide material can comprise or be selected from a group of materials consisting of (Al₂O₃), silicon oxide (SiO₂ ), cerium oxide (CeO₂), zirconium oxide (ZrO₂), iron oxide (FeOx), and/or aluminosilicates. This can include their nanoparticle variations and/or their nanoporous or mesoporous variations. The oxide material can additionally or alternatively be selected from a group additionally including aluminosilicate, mesoporous ceramics, and/or their related nanoparticles.

In some variations, the carrier layer can be made of a combination of oxide materials. Accordingly, the carrier layer can be made as a combination of oxide materials comprising or selected from a group consisting of aluminum oxide (Al₂O₃), silicon oxide (SiO₂ ), cerium oxide (CeO₂), zirconium oxide (ZrO₂), iron oxide (FeOx), and aluminosilicates, and mesoporous ceramics and/or their related nanoparticles.

In a nanoporous variation of the carrier layer, the carrier layer can be made of or include materials in addition to or as an alternative to oxide materials. For example, the carrier layer can be made of or include materials such as activated carbon, quartz, zeolite, carbon nanotube, organometallic frame material (OFM), and covalent organic frame material (COF). In one example, quartz (e.g., silicon dioxide SiO₂ ) can be used as an oxide material in the carrier layer. In another example, zeolite (e.g. a microporous crystalline aluminosilicate material) can be usable as a material in the carrier layer. Accordingly, the nanoporous material can be a material comprising, selected from, or be a combination of materials selected from a group consisting of activated carbon, quartz, zeolite, carbon nanotubes, organometallic frame material, and covalent organic frame material.

The capture layer functions to establish ionic functional groups into or around the structure of the carrier layer. More specifically, anion functional groups can be established for chemically adsorbing and desorbing carbon dioxide depending on state of a humidity swing (e.g., dry conditions or wetted conditions). The anions are preferably part of ionic pairs and more specifically neutral ionic pairs. An ionic pair can include at least one cation and at least one anion. In some embodiments, the ratio of cation to anion is one-to-one. In some embodiments, the ratio of cation to anion is not one-to-one. The ionic pairs are preferably neutral though some variations can include a charge imbalance. In one example, a neutral ionic pair can be two glycidyltrimethylammonium (GTA⁺) cations and one carbonate anion (CO₃²⁻).

The adsorption site can be a carbon dioxide adsorption site, but the capture layer can alternatively use ion-modified material to establish adsorption sites for one or more other target gases such as SO₂, H₂S, and NOx. A hydration shell can form about the anions to serve as the adsorption site, wherein the adsorption site (or more specifically the hydration shell) around each anion of the set of ionic pairs is conditional on the humidity state.

In some embodiments, when in a condition for a hydration shell based on the water molecule number, presence of carbon dioxide drives a first reaction between carbon dioxide, the hydration shell, and the anion for at formation of at least a bicarbonate ion within the hydration shell.

In some embodiments, the condition for the hydration shell based on the water molecule number is when the number of water molecules is less than at least 50 per anion. In some embodiments, the condition for the hydration shell based on the water molecule number is when the number of water molecules is less than at least 30 per anion. In some embodiments, the condition for the hydration shell based on the water molecule number is when the number of water molecules is less than at least 20 per anion. In some embodiments, the condition for the hydration shell based on the water molecule number is when the number of water molecules is less than at least 10 per anion.

In some embodiments, when in a condition for breakdown of the hydration shell based on the water molecule number, the hydration shell breaks down through a second reaction that releases CO₂ from the bicarbonate ion into an aqueous solution (e.g., water).

In some embodiments, the condition for breakdown of the hydration shell based on the water molecule number is when the number of water molecules is greater than 50 per anion. In some embodiments, the condition for breakdown of the hydration shell based on the water molecule number is when the number of water molecules is greater than 30 per anion. In some embodiments, the condition for breakdown of the hydration shell based on the water molecule number is when the number of water molecules is greater than 20 per anion. In some embodiments, the condition for breakdown of the hydration shell based on the water molecule number is when the number of water molecules is greater than 10 per anion.

The positive charge ions (cations) can be cations such as sodium ions (Na⁺), potassium ions (K⁺), and/or GTA⁺. Accordingly, the cations can comprise or be selected from a positive charge ion group (i.e., cation group) consisting of Na⁺, K⁺, and glycidyltrimethylammonium (GTA⁺). The negative charge ions (anions) can comprise or be selected from a negative charge ion group (i.e., anion group) consisting of carbonate (CO₃²⁻), oxalate (C₂O₄²⁻), phosphate (PO₄³⁻), phosphite (PO₃²⁻), sulfate (SO₄²⁻), sulfite (SO₃²⁻), silicate (SiO₄⁴⁻), and borate (BO₃³⁻). In some variations, the anions can be a combination of different types of anions selected from the negative charge ion group. Similarly, the cations can be a combination of different types of cations selected from the positive charge ion group.

In some variations, corresponding anion salts can be used. Accordingly, the ion-modified material can be or include a combination of ion-modified materials comprising or selected from a group of salts consisting of sodium phosphate, sodium phosphite, sodium sulfite, sodium sulfate, sodium borate, sodium oxalate, and sodium carbonate. Other suitable anion materials or salts can alternatively be used.

The sorbent in the presence of a gas stream can preferably adsorb CO₂, and convert CO₂ to bicarbonate (HCO₃⁻). That formation of bicarbonate can be accompanied by generation of the protonated form of the anion of the ionic pair, such as HC₂O₄₋, HPO₄²⁻, HPO₃⁻, HSO₄, HSO₃, HSiO₄³⁻, HBO₃²⁻, or another HCO₃⁻. The anion can thus capture and hold the CO₂ until exposure to H₂O can be used to release the CO₂. Drying of the sorbent after washing the sorbent preferably resets the adsorption sites of the sorbent. Accordingly, in a dry state, the sorbent in the presence of a gas stream will adsorb CO₂ through conversion of CO₂ to bicarbonate and a protonated form of the anion, and, in a wetted state the sorbent releases CO₂, and the capture layer reverts back to the ion-modified material when returned to a dry state. This capture and release can be driven at least in part by the presence of a stable hydration shell. As discussed, the hydration shell can be possible around the ions of ionic pairs when water concentration in the environment of the material is appropriate and the ionic pairs are appropriately spaced.

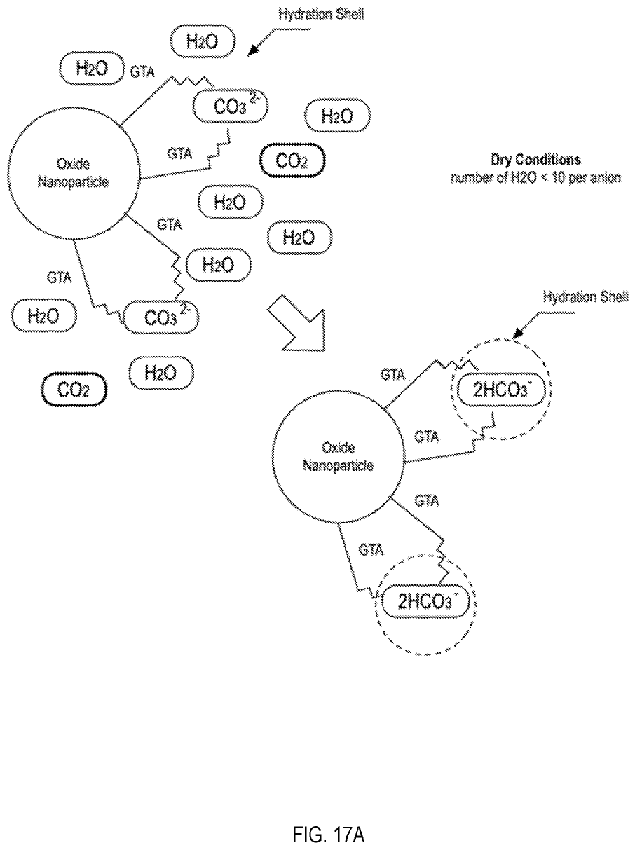

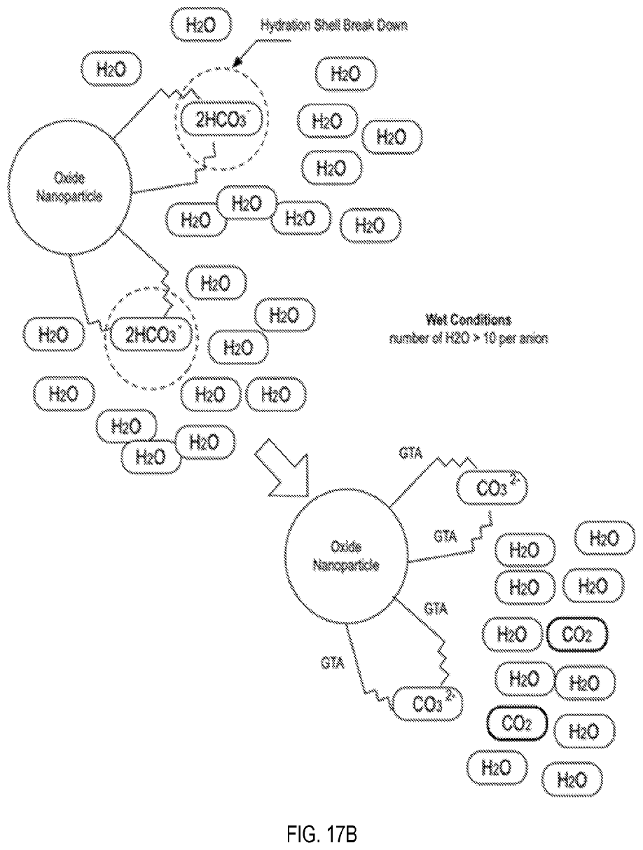

The sorbent can capture or release carbon dioxide based on the humidity state of the environment around the sorbent material, which influences the conditions for water molecules forming a hydration shell or behaving as bulk water (e.g., aqueous water). Accordingly, when in a condition for formation of a hydration shell (which can be based on the water molecule number count per anion), presence of carbon dioxide drives a first reaction between carbon dioxide, a water molecule of the hydration shell, and the anion for formation of a bicarbonate ion, and a protonated form of the anion within the hydration shell, as shown in FIG. 17A.

The condition for the hydration shell based on the water molecule number can be when the number of water molecules is fewer than at least 50 per anion, fewer than 40 per anion, fewer than 30 per anion, fewer than 20 per anion, and/or fewer than 10 per anion, depending on exact implementation. For example, in some variations, the hydration shell can occur when there are fewer than 10 water molecules present for interactions per anion.

Condition for breakdown of the hydration shell can similarly be based on the water molecule number per anion. When in condition for breakdown of the hydration shell, the hydration shell breaks down through a second reaction that releases CO₂ from the bicarbonate ion into an aqueous solution (e.g. water) as shown in FIG. 17B.

The condition for breakdown of the hydration shell can be when the number of water molecules is greater than 50 per anion, greater than 40 per anion, greater than 30 per anion, greater than 20 per anion and/or greater than 10 per anion, depending on exact implementation. For example, in some variations, the hydration shell can break down releasing captured CO₂ when there are more than 10 water molecules present per anion for interactions resulting in water behaving as bulk water. It will be understood that the number of water molecules per anion suitable for formation of a stable hydration shell can depend on the ionic material (e.g. the anion), and/or on the carrier layer.

In one example, a humidity swing sorbent uses a carrier layer made of SiO₂ nanoparticles with a capture layer using ionic pairs with a combination of GTA⁺ cations and carbonate anions. In this exemplary variation, the humidity swing transitions will be able to capture carbon dioxide in dry conditions based on the below reaction: (in which n is the water number, also referred to as the number of water molecules per anion)

Dry: CO₃²⁻+nH₂O+CO₂→2HCO₃⁻+(n-1)H₂O, n<10.

And the humidity swing transitions will be able to release adsorbed carbon dioxide in wetted conditions based on the below reaction:

Wet: 2HCO₃⁻+(n-1)H₂O→CO₃⁻²+nH₂O+CO₂, n>10.

In a similar example, a nanoporous sorbent, a humidity swing sorbent uses a carrier layer made of nanoporous material such as COF or MOF with a capture layer using ion-modified material with a combination of GTA⁺ cation and carbonate anion. In this variation, the at least one anion of an ionic pair is a carbonate. In this exemplary variation, the humidity swing transitions will similarly be able to capture carbon dioxide in dry conditions based on the below reaction:

Dry: CO₃²⁻+nH₂O+CO₂→2HCO₃⁻+(n-1)H₂O, n<10.

And the humidity swing transitions will be able to release adsorbed carbon dioxide in wetted conditions based on the below reaction:

Wet: 2HCO₃⁻+(n-1)H₂O→CO₃⁻²+nH₂O+CO₂, n>10.

When wetted, the bicarbonate reverts to released CO₂ and the carbonate anion of the ionic pair.

In another variation, the at least one anion is a sulfite ion (SO₃²⁻). This anion can similarly drive reactions in dry humidity conditions and wet humidity conditions. The first reaction (with hydration shell conditions) can be characterized by:

SO₃²⁻+nH₂O+CO₂→HSO₃⁻HCO₃⁻+(n-1)H₂O, n<10

and the second reaction can be characterized by:

HSO₃⁻HCO₃⁻+(n-1)H₂O >SO₃²⁻+nH₂O+CO₂, n>10.

In some embodiments, the at least one anion is a phosphite ion (PO₃₃-). This anion can similarly drive reactions in dry humidity conditions and wet humidity conditions. The first reaction (with hydration shell conditions) can be characterized by:

PO₃-+nH₂O+CO₂→HPO₃⁻HCO₃⁻+(n-1)H₂O, n<10

and the second reaction can be characterized by:

HPO₃⁻HCO₃⁻+(n-1)H₂O→PO₃³⁻+nH₂O+CO₂, n>10.

In some embodiments, the at least one anion is a phosphate ion (PO₄³⁻). This anion can similarly drive reactions in dry humidity conditions and wet humidity conditions. The first reaction (with hydration shell conditions) can be characterized by:

PO₄³⁻+nH₂O+CO₂→HPO₄²⁻HCO₃⁻+(n-1)H₂O, n<10

and the second reaction can be characterized by:

HPO₄²⁻HCO₃⁻+(n-1)H₂O→PO₄³⁻+nH₂O+CO₂, n>10.

It will be appreciated that in some embodiments, the at least one anion is a borate (BO₃³⁻), oxalate (C₂O₄²⁻), silicate (SiO₄⁴⁻) or sulfate (SO₄²⁻) anion, which can similarly drive reactions in dry humidity conditions and wet humidity conditions by first (with hydration shell conditions) and second reactions corresponding to those disclosed hereinabove.

### 3. Method of Producing the Sorbent Composition

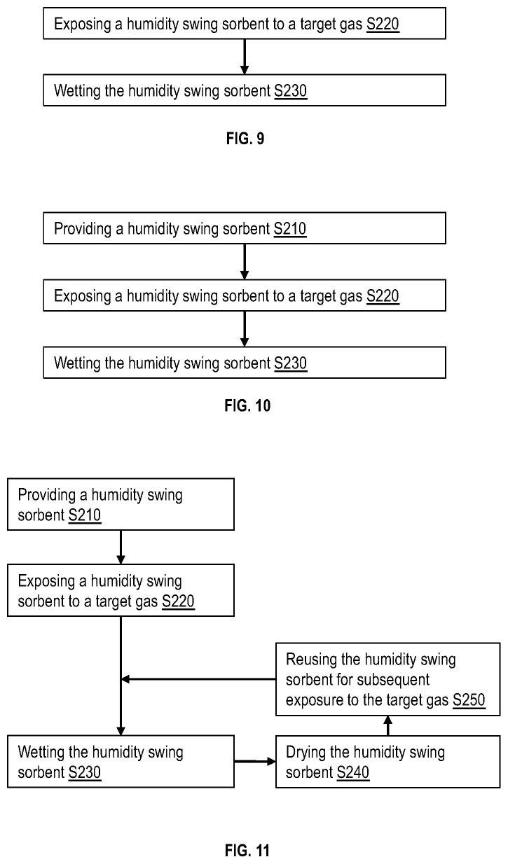

A method for producing a humidity swing sorbent can include: supplying a sorbent carrier layer S110; and reacting or grafting an ion-functional group to the carrier layer S120 as shown in FIG. 6. The ion-functional group can be reacted or grafted as a capture layer, which can have at least one adsorption site. The capture layer will preferably include adsorption sites distributed across the carrier layer. This adsorption site can be a carbon dioxide capture site or a capture site for any other type of targeted gas.

The method can be used in producing a humidity swing sorbent including any of the sorbent variations described herein. In this way the carrier layer and the ion-functional group (e.g., the ion-modified material(s) of a capture layer) can be any of the materials described herein and/or include any of the properties described herein.

In one variation, the method for production of a sorbent used for capture of carbon-dioxide using a humidity swing material can include: supplying a sorbent carrier layer that is made of an oxide material (S110); and reacting an ion-functional group to the carrier layer as a carbon dioxide capture layer (S120). This method can be used in creating a sorbent with a nanoporous or mesoporous carrier layer. This method can also be used for creating a sorbent with a carrier layer made from an oxide material, such as oxide nanoparticles.

In another variation, the method for production of a sorbent used for capture of carbon-dioxide using a humidity swing material can include: supplying a sorbent carrier layer that is made of a porous material (S110); and reacting an ion-functional group to the carrier layer as a carbon dioxide capture layer (S120). This method can be used in creating a sorbent with a nanoporous or mesoporous carrier layer, which can be made of oxide materials and some non-oxide materials such as activated carbon, quartz, zeolite, carbon nanotube, organometallic frame (MOF) material, and covalent organic frame (COF) material.

Various production processes can be used in producing the humidity swing sorbent. In one method variation shown in FIG. 7, producing the humidity swing sorbent can include: supplying the sorbent carrier layer S110 which comprises providing an oxide material suspension in a solution S111; and reacting or grafting the ion-functional group to the carrier layer as the capture layer S120 can include: cleansing a cation exchange resin with deionized water S121; performing an ion exchange by adding the cation exchange resin to the solution S122; mixing glycidyltrimethylammonium chloride to the solution S123; and mixing a salt containing the anions to the solution S124. Without wishing to be bound by theory, it is believed that in the step of mixing GTAC with the solution (S123), GTAC reacts with an oxygen-containing group on the surface of the oxide, thereby grafting GTAC to the oxide. More particularly, it can be that hydroxide groups on the surface of the oxide react with the epoxide of GTAC, opening the ring and forming an O—C covalent bond between the surface of the oxide and the GTAC. It is further believed that when a salt containing the anion (such as an alkali metal salt, for example sodium carbonate), the anion (e.g. carbonate) is displaced by chloride (e.g. forming sodium chloride) so that the anion forms an ‘ionic pair’ with the surface-bound GTA⁺ cation (for example wherein the ‘ionic pair’ if made up of two surface bound GTA⁺ groups and one anion in the case of carbonate). The chloride-containing salt (e.g. NaCl) can then be separated, for example by remaining in solution when the functionalized sorbent material is extracted.

Such processes can be more specifically implemented, as shown in FIG. 8, such that a method variation for producing the sorbent includes in one example: providing 5% w.t. oxide material suspension in a water (S111); running deionized water through a cation exchange resin until transparent water is collected, thereby cleansing the cation exchange resin (S121); performing an ion exchange by adding the cation exchange resin to the oxide-containing solution four times (S122); mixing 6 mmol glycidyltrimethylammonium chloride with every 1 gram of oxide solution prepared in the solution (S123); stirring the solution; mixing anions to the solution in the form of salts (such as alkali metal salts) S124; and centrifuging the solution. The step of centrifuging the solution separates the functionalized sorbent material from the water solution, and thus also from the highly soluble chloride-containing salt (e.g. NaCl).

Block S110, supplying the sorbent carrier layer, functions to establish the sorbent carrier layer. The carrier layer in some variations is a nanoporous or more specifically a mesoporous material with a corresponding nanoporous or mesoporous structure. For example, the carrier layer can be made of a ceramic material that is a nanoporous or more specifically a mesoporous oxide material. In particular, the nanoparticles can be oxide nanoparticles. The carrier layer in some variations includes or is made of a nanoparticle material.

In some variations, the carrier layer can include or be made of a material or combination of materials such as aluminum oxide (Al₂O₃), silicon oxide (SiO₂ ), cerium oxide (CeO₂), zirconium oxide (ZrO₂), iron oxide (FeOx), and aluminosilicates. Such oxide materials can be used in nanoporous or mesoporous forms. Alternatively, oxide nanoparticles can be supplied as the carrier layer. In some nanoporous/mesoporous variations, the carrier layer can include or be made of a material or combination of materials such as activated carbon, quartz, zeolite, carbon nanotube, organometallic frame material, and covalent organic frame material.

In one particular method of producing the sorbent, supplying the sorbent carrier layer can include providing an oxide material suspension in a solution S111, which functions to create a solution with a suitable carrier layer material suspended. This can be then be used in producing a resulting sorbent as described above. For example, the oxide material suspension could comprise aluminum oxide (Al₂O₃), silicon oxide (SiO₂ ), cerium oxide (CeO₂), zirconium oxide (ZrO₂), iron oxide (FeOx), and/or alternatively an aluminosilicate.

In one variation, the solution is water wherein the oxide material suspension is provided in water. Furthermore, in some variations, 1%-30% w.t. about 5% w.t. of the oxide material can be provided in the water as a suspension. For example, 4-6% (e.g., 5%) w.t. of the oxide material can be provided in the water as a suspension.

Block S120, which includes reacting or grafting the ion-functional group to the carrier layer as the capture layer, functions to establish ion-functional groups with an adsorption site on material of the carrier layer. Various approaches can be used to chemically or structurally react or graft the ion-functional group materials to the carrier layer. Preferably, according to the step of block S120, the cation of the ionic pair is reacted or grafted onto the carrier layer, and the anion of the ionic pair is associated with the cation.

Block S121, which includes running deionized water through a cation exchange resin, functions to prepare the cation exchange resin.

In one variation, the deionized water is run through the cation exchange resin (or more generally an ion exchange resin i.e., an IER) until transparent water is collected.

Block S122, which includes performing an ion exchange by adding the cation exchange resin to the solution, can function to clean impurity and clean out pre-existing ions or materials present in the oxide. In one variation, the cation exchange resin is added to the solution to do ion exchange at least four times or more.

Block S123, which includes mixing glycidyltrimethylammonium chloride (GTAC) to the suspension (i.e., the ion exchanged oxide suspension), functions to attach or otherwise enable grafting of cations on the surface of the carrier layer (e.g., the oxide material carrier layer). This can additionally or alternatively include mixing salts such as carbonate salts, oxalate salts, sulfate salts, sulfite salts, phosphate salts, phosphite salts, and borate salts (e.g., Na₂CO₃, K₂CO₃, Na₂C₂O₄, K₂C₂O₄, Na₃PO₄, K₃PO₄, Na₃PO₃, K₃PO₃, Na₂SO₄, K₂SO₄, Na₂SO₃, K₂SO₃, Na₃BO₃, K₃BO₃, etc.). In one variation, 6 mmol of glycidyltrimethylammonium chloride is mixed to the solution for every 1 gram of the solution of oxide suspension. This can in some variations have a mass ratio of 1-10 GTAC to 1 oxide materials. After mixing the GTAC, the method can include stirring or otherwise mixing the solution.

Block S124, which includes mixing a salt comprising the ionic pair anions to the solution, functions to introduce anions that associate with the carrier layer, e.g. via a bonded or grafted cation. The anions preferably become distributed across the surface of the nanoporous or mesoporous the carrier layer, thereby providing a large surface area where capture of CO₂ can occur. Examples of such an anion material can include sodium phosphate, sodium sulfite, sodium borate, or sodium carbonate, and/or other salts, such as those disclosed herein. In other variations, the anion material can include: phosphate, sulfite, and/or borate. In some nanoporous carrier layer variations, such as where the carrier layer includes activated carbon, quartz, zeolite, carbon nanotube, organometallic frame material, and covalent organic frame material, the anion material can be or include carbonate ions, sulfite ions, phosphate ions and borate ions.

In an oxide nanoparticle variation of the carrier layer, anions can bond at various locations around the nanoparticle, resulting in high surface area exposure to carbon dioxide adsorption sites.

Such a process can additionally include centrifuging a resulting solution after providing the anions. Other separation processes can alternatively be used.

### 4. Method of Direct Air Capture

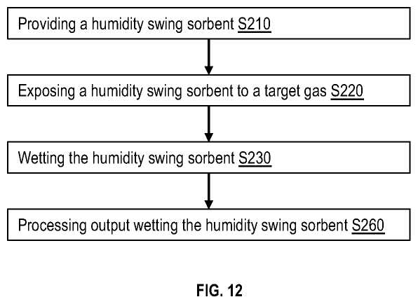

As shown in FIG. 9, a method for capture of a target gas using a humidity swing sorbent can include exposing a humidity swing sorbent to a target gas S220, and wetting the humidity swing sorbent S230. The method can additionally include providing a humidity swing sorbent S210 as shown in FIG. 10. The humidity swing sorbent is preferably a sorbent such as one of the variations described herein. Accordingly, humidity swing sorbent can be a material that includes: a sorbent carrier layer of an oxide material and/or a nanoporous material, and a capture layer, the capture layer comprising an ion-modified material having at least one adsorption site (e.g., a carbon dioxide adsorption site).

In some variations, the humidity swing sorbent can be reusable. Accordingly, as shown in FIG. 11, a method for capture of a target gas using a humidity swing sorbet can include: providing a humidity swing sorbent S210; exposing a humidity swing sorbent to a target gas S220; wetting the humidity swing sorbent S230; drying the humidity swing sorbent S240 and reusing the humidity swing sorbent for subsequent exposure to the target gas S250.

Target gases that are adsorbed can preferably be extracted into a contained liquid form after the wetting of a loaded (or partially loaded humidity swing sorbent. The output of this wetting process can subsequently be processed to isolate or transform the target gas into a desired form for some other use (e.g., storage, use in other chemical processes). Accordingly, in some variations, the method can involve processing output wetting the humidity swing sorbent S260 as shown in FIG. 12.

The method can be particularly applied to the capture and collection of target acidic gases like carbon dioxide. For example, the method can be used for the direct air capture of CO₂ for sequestration. The method can alternatively be used for capturing other target gases from other gas streams such as industrial gas streams where it can be desired to capture target gases.

Block S210, which includes providing a humidity swing sorbent S210, which functions to produce or otherwise use a humidity swing sorbent. The humidity swing sorbent is preferably a variation of a sorbent as described herein. The humidity swing sorbent can similarly be produced using any suitable method including method for production of a sorbent as describe herein.

Block S220, which includes exposing a humidity swing sorbent to a target gas, which functions to pass a gas through the humidity swing sorbent such that a target gas like carbon dioxide can be adsorbed in the sorbent.

The target gas can be part of any other collection of gas. In one variation where the method is used for direct air capture, the target gas can be part of natural air. In another variation, the target gas can be part of an industrial gas stream.

Exposure to the humidity swing sorbent can use any suitable process such as forcing or otherwise directing a gas stream through the sorbent. Active systems such as fans can be used. Alternatively, the humidity swing sorbent can be integrated within a capture device that is exposed to a moving gas stream. In another variation, the humidity swing sorbent can be passively exposed where ambient air or gas motion is used.

The moisture swing sorbent can be exposed such that the sorbent is fully or substantially loaded with target gas before proceeding with extraction. The sorbent can, however, be loaded to any suitable level before proceeding. In one variation, the duration of exposure can be time based or some calculation of gas volume or quantification to determine when transitioning.

In one variation, the method can include monitoring CO₂ concentrations to track, monitor or otherwise quantify amount of carbon dioxide adsorbed by the sorbent. In one exemplary implementation, an infrared gas analyzer can be used.

In one variation, the humidity swing sorbent can be exposed to a gas stream with a target gas for a time window corresponding to targeted adsorption. As shown in FIG. 3, a time window ranging from 30 minutes to 90 minutes can be used. In some variations, 10-30 minutes can be sufficient for charging or loading the sorbent. In one exemplary implementation, 1 gram of sorbent can capture 0.8 mmol of CO₂, though adsorption ratios can vary depending on implementation.

Adsorption of the CO₂ can be driven through a reaction such as one below, which will be driven during dry conditions.

Dry: CO₃²⁻+nH₂O+CO₂→2HCO₃⁻+(n-1)H₂O, n<10.

Block S230, which includes wetting the humidity swing sorbent, functions to trigger a humidity swing reaction that releases captured compounds (e.g., the targeted gases like carbon dioxide) into an output solution. Wetting the humidity swing sorbent preferably uses water but other aqueous solutions, water vapor, or other wetting solutions can be used. Exposing the humidity swing sorbent to water or another suitable solution preferably results in target gas ionically bonded or otherwise captured by the anion materials to be released. Passing water through the sorbent washes the select target gases out. The output of this process can be described or characterizing as output water or an output solution.

Desorption of the CO₂ can be driven through a reaction such as the one below, which will be driven during wet conditions.

Wet: 2HCO₃⁻+(n-1)H₂O→CO₃²⁻+nH₂O+CO₂, n>10.

Wetting of the humidity swing sorbent can be performed for some amount of time, which can be calculated based on predicted quantities of the target gas captured in the sorbent.

As shown in FIG. 3, a wetting time window ranging from 30 minutes to 90 minutes can be used. In one exemplary implementation, 3 grams of water vapor can be used to trigger desorption of 1 gram of CO₂.

As mentioned, some variations of the method can include processing the humidity swing sorbent for reuse, which can include drying the humidity swing sorbent S240 and reusing the humidity swing sorbent for subsequent exposure to the target gas S250.

Block S240, which includes drying the humidity swing sorbent, which functions to reduce the moisture content of the moisture swing sorbent. This preferably happens after wetting the moisture swing sorbent and desorbing all or a substantial amount (e.g., greater than 75%) of captured target gas. Drying functions to reset the adsorption sites of a capture layer of the sorbent.

Block S250, which includes reusing the humidity swing sorbent for subsequent exposure to the target gas, functions to use the swing sorbent for capturing more target gas. The sorbent can preferably be reused any suitable number of times by repeating S240 and S250 after loading and unloading target gases from the sorbent.

Block S260, which includes processing output of the wetted humidity swing sorbent, functions to extract or otherwise prepare target gas as an output from a wetting process (S230).

In some variations, an output of S230 can be a water output that contains gaseous forms of the target gases contained within it. In such variations, processing output of the wetted humidity swing sorbent can include extracting captured target gas from the output water using depressurization. A vacuum can be used to establish a negative pressure differential resulting in gaseous target gases to be pulled from the water. This isolated gaseous form of the target gas can then be subsequently processed. For example, processing the output of wetting the humidity swing sorbent can additionally include compressing captured target gas into a liquid form.

Gaseous or liquid forms of the target gas can be stored for sequestration. They can also be reused in various industrial applications.

### 5. System for Direct Air Capture

As shown in FIG. 5, a system for adsorbing target gases using a humidity swing sorbent can include a humidity swing sorbent 110, gas exposure system 120, a wetting system 130, a sorbent restoring system 140, and optionally a water processing system 150. In particular, the system can be used for the capture of carbon dioxide. The system can be used for direct air capture. The system can alternatively be used in capture of carbon dioxide from other gas streams such as industrial gas streams.

In one variation, the humidity swing sorbent 110 can be integrated within a chamber or body, where the gas exposure system 120, the wetting system 130, and the sorbent restoring system 140 can be integrated to act on the humidity swing sorbent 110 within the chamber/body. In another variation, the humidity swing sorbent 110 can be moved or otherwise transported between one or more of the system components to facilitate adsorption of carbon dioxide, desorption of the carbon dioxide, and/or restoring of the humidity swing sorbent 110.

The humidity swing sorbent 110 functions to enable humidity swing reactions to adsorb carbon dioxide during loading and then with changes in humidity state desorption of the carbon dioxide gas. The humidity swing sorbent 100 can be any variation of sorbent described herein.

The gas exposure system 120 functions to facilitate directing a gas at and/or through the humidity swing sorbent 110. In one variation, the gas exposure system 120 directs air or a gas through a passageway in which is located the humidity swing sorbent 110, thereby exposing the sorbent to the air or gas. In particular, air/gas can be passed through a filter made of, or comprising, the humidity swing sorbent 110. The gas exposure system 120 can include an air inlet and an outlet.

The system can include a sensing system to quantify and monitor loading of the humidity swing sorbent 110. For example, an infrared gas analyzer can be used to track carbon dioxide adsorbed.

The wetting system 130 functions to expose the humidity swing sorbent 110 to water or another suitable (e.g. aqueous) solution. The wetting system can be connected to a water outlet or a water vapor source. After a humidity swing sorbent 110 has been partially or fully loaded, the wetting system 130 can activate to change the humidity/moisture level to a state triggering desorption of the carbon dioxide from the humidity swing sorbent 110.

The wetting system 130 preferably includes a water output stream which can be some output or outlet of liquid water or water vapor. The desorbed or released carbon dioxide gas preferably gets mixed with the water output stream.

The sorbent restoring system 140 functions to re-establish dry conditions, thereby resetting the adsorption capabilities of the humidity swing sorbent 110. The sorbent restoring system 140 can include heaters, fans, and/or other elements to facilitate drying of the humidity swing sorbent 110.

In some variations, the system can also include a water processing system 150, which functions to extract or transform the state of carbon dioxide in the water output stream of the wetting system 130. The water processing system can include a vacuum chamber and/or a pressurization chamber to extract carbon dioxide gas from water and/or to liquify the carbon dioxide. The system can include other processing systems to transform the carbon dioxide gas into other forms. The different forms of carbon dioxide product output can be customized for different downstream utilization needs. For example, air with approximately 420 ppm of CO₂ (e.g., 0.042%) can be converted by the system to suitable forms such as a fluid comprising approximately 1000 ppm (0.1%) CO₂ for greenhouse fertilization, 5-20% for cement curing and algae, 15-30% for mineralization, and/or 99.9% for sustainable fuel.

As used herein, first, second, third, etc. are used to characterize and distinguish various elements, components, regions, layers and/or sections. These elements, components, regions, layers and/or sections should not be limited by these terms. Use of numerical terms can be used to distinguish one element, component, region, layer and/or section from another element, component, region, layer and/or section. Use of such numerical terms does not imply a sequence or order unless clearly indicated by the context. Such numerical references can be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following clauses and claims.

The present disclosure can also be described by the following numbered clauses:
1. A composition for a sorbent used for adsorption of carbon dioxide comprising:
   a sorbent carrier layer that is made of an oxide material; and
   a capture layer, the capture layer comprising a set of neutral ionic pairs with at least one cation and at least one anion, wherein the set of neutral ionic pairs are spatially distributed across scaffolding of the oxide material such that the anions of each neutral ionic pair are spaced for formation of a hydration shell around each anion,
   wherein the hydration shell around the anion is a carbon dioxide adsorption site; optionally wherein the composition is a sorbent composition according to any one of clauses 44 to 57.
2. The composition of clause 1, wherein the oxide material is selected from a group of materials consisting of aluminum oxide (Al₂O₃), silicon oxide (SiO₂ ), cerium oxide (CeO₂), zirconium oxide (ZrO₂), iron oxide (FeOx), and aluminosilicates.
3. The composition of clause 1 or clause 2, wherein the oxide material is a combination of materials selected from a group consisting of aluminum oxide (Al₂O₃), silicon oxide (SiO₂ ), cerium oxide (CeO₂), zirconium oxide (ZrO₂), iron oxide (FeOx), aluminosilicates, and mesoporous ceramics.
4. The composition of any preceding clause, wherein the oxide material is a nanoporous oxide material, and optionally wherein the set of neutral ionic pairs that are spatially distributed through scaffolding of the oxide material are contained in pores of the oxide nanoporous material.
5. The composition of clause 4, wherein the oxide material is a mesoporous oxide material.
6. The composition of clause 4 or clause 5, wherein neutral ionic pairs contained in the pores of oxide nanoporous material have non-crystalline spacing of anions for hydration shell formation, and/or wherein there are less than 20 anions in each pore.
7. The composition of any preceding clause, wherein the oxide material is an oxide nanoparticle material, and wherein the set of neutral ionic pairs that are spatially distributed across scaffolding of the oxide material is spaced by each cation of the at least one cation being grafted spatially on an oxide nanoparticle of the oxide nanoparticle material.
8. The composition of clause 4, wherein there are multiple neutral ionic pairs that are grafted onto the nanoparticle of the oxide material.
9. A composition for a sorbent used for adsorption of carbon dioxide comprising:
   a sorbent carrier layer that is made of a nanoporous material; and
   a capture layer, the capture layer comprising a set of neutral ionic pairs of at least one cation and at least one anion, wherein the ionic pairs are contained in pores of the nanoporous material such that anions of the set of neutral ionic pairs are spaced within the pores for formation of a hydration shell, and wherein the hydration shell around each anion of the set of neutral ionic pairs is a carbon dioxide adsorption site;
optionally wherein the composition is a sorbent composition according to any one of clauses 44 to 57.
10. The composition of clause 9, wherein the nanoporous material is a mesoporous material.
11. The composition of clause 9 or clause 10, wherein the nanoporous material is a material selected from a group consisting of activated carbon, quartz, zeolite, carbon nanotubes, organometallic frame material, and covalent organic frame material.
12. The composition of any one of clauses 9-11, wherein the nanoporous material is a nanoporous oxide material.
13. The composition of clause 12, wherein the nanoporous oxide material is selected from a group of materials consisting of aluminum oxide (Al₂O₃), silicon oxide (SiO₂ ), cerium oxide (CeO₂), zirconium oxide (ZrO₂), iron oxide (FeOx), and aluminosilicates.
14. The composition of clause 12, wherein the nanoporous oxide material is a combination of materials selected from a group consisting of aluminum oxide (Al₂O₃), silicon oxide (SiO₂ ), cerium oxide (CeO₂), zirconium oxide (ZrO₂), iron oxide (FeOx), and aluminosilicate, and mesoporous ceramics.
15. The composition of any preceding clause, wherein the hydration shell around each anion of the set of neutral ionic pairs is conditional on humidity state.
16. The composition of any preceding clause, wherein, when in a condition for a hydration shell based on the water molecule number, presence of carbon dioxide drives a first reaction between carbon dioxide, the hydration shell, and the anion for formation of at least a bicarbonate ion within the hydration shell.
17. The composition of clause 3, wherein the condition for the hydration shell based on the water molecule number is when the number of water molecules is less than at least 50 per anion.
18. The composition of any preceding clause, wherein, when in a condition for breakdown of the hydration shell based on the water molecule number, the hydration shell breaks down through a second reaction that releases CO₂ from the bicarbonate ion into aqueous water.
19. The composition of clause 18, wherein the condition for breakdown of the hydration shell based on the water molecule number is when the number of water molecules is greater than 50 per anion.
20. The composition of any preceding clause, wherein the at least one anion is a borate ion (BO₃³⁻), wherein the first reaction is characterized by:

BO₃³⁻+nH₂O+CO₂→HBO₃²⁻+HCO₃⁻+(n-1)H₂O,

and the second reaction is characterized by:

HBO₃²⁻+HCO₃⁻+(n-1)H₂O→BO₃³⁻+nH₂O+CO₂.
21. The composition of any preceding clause, wherein the at least one anion is a carbonate ion (CO₃²⁻), wherein the first reaction is characterized by:

CO₃²⁻+nH₂O+CO₂→2HCO₃⁻+(n-1)H₂O,

and the second reaction is characterized by:

2HCO₃⁻+(n-1)H₂O→CO₃²⁻+nH₂O+CO₂.
22. The composition of any preceding clause, wherein the at least one anion is an oxalate ion (C₂O₄²⁻), wherein the first reaction is characterized by:

C₂O₄²⁻+nH₂O+CO₂→HC₂O₄₋+HCO₃⁻+(n-1)H₂O,

and the second reaction is characterized by:

HC₂O₄₋+HCO₃⁻+(n-1)H₂O→C₂O₄²⁻+nH₂O+CO₂.
23. The composition of any preceding clause, wherein the at least one anion is a sulfite ion (SO₃²⁻), wherein the first reaction is characterized by:

SO₃²⁻+nH₂O+CO₂→HSO₃+HCO₃⁻+(n-1)H₂O,

and the second reaction is characterized by:

HSO₃+HCO₃⁻+(n-1)H₂O→SO₃²⁻+nH₂O+CO₂.
24. The composition of any preceding clause, wherein the at least one anion is a phosphite ion (PO₃³⁻), wherein the first reaction is characterized by:

PO₃³⁻+nH₂O+CO₂→HPO₃⁻+HCO₃⁻+(n-1)H₂O,

and the second reaction is characterized by:

HPO₃⁻+HCO₃⁻+(n-1)H₂O→PO₃³⁻+nH₂O+CO₂.
25. The composition of any preceding clause, wherein the at least one anion is a phosphate ion (PO₄³⁻), wherein the first reaction is characterized by:

PO₄³⁻+nH₂O+CO₂→HPO₄²⁻+HCO₃⁻+(n-1)H₂O,

and the second reaction is characterized by:

HPO₄²⁻+HCO₃⁻+(n-1)H₂O→PO₄³⁻+nH₂O+CO₂.
26. The composition of any preceding clause, wherein the hydration shell has 1-3 levels.
27. The composition of any preceding clause, wherein, in a dry state, the sorbent in the presence of a gas stream will adsorb CO₂ through conversion of CO₂ to carbonate, and, in a wetted state the sorbent releases CO₂ and the capture layer reverts back to the set of neutral ionic pairs with a hydration shell when returned to the dry state.
28. The composition of any preceding clause, wherein the at least one cation is selected from a positive charge ion group consisting of Na⁺, K⁺, and glycidyltrimethylammonium (GTA⁺), and/or wherein the at least one anion is selected from a negative charge ion group consisting of carbonate (CO₃²⁻), oxalate (C₂O₄²⁻), phosphate (PO₄³⁻), phosphite (PO₃²⁻), sulfite (SO₃²⁻), sulfate (SO⁴⁻), borate (BO₃³⁻), and silicate (SiO₄⁴⁻).
29. The composition of clause 28, wherein the set of neutral ionic pairs is a combination of neutral ionic pairs with different anions selected from the negative charge ion group.
30. A method for production of a carbon dioxide sorbent comprising:
   supplying a sorbent carrier layer that is made of an oxide material;
   reacting an ion-functional group to the carrier layer as a capture layer, the ion functional group having at least one carbon dioxide adsorption site;
   optionally wherein the method comprises a method according to any one of clauses 58 to 68.
31. The method of clause 30, wherein supplying the sorbent carrier layer comprises providing an oxide material suspension in a solution; and wherein reacting the ion-functional group to the carrier layer as the capture layer comprises:
   optionally running deionized water through a cation exchange resin to cleanse the resin,
   performing an ion exchange by adding the cation exchange resin to the solution of suspended oxide material,
   mixing glycidyltrimethylammonium chloride (GTAC) into the solution of suspended oxide material, and
   mixing a salt comprising an anion (such as a multivalent anion) to the solution of suspended oxide material mixed with GTAC.
32. The method of clause 31, wherein the oxide material suspension is in water, for example comprising about 5% w.t. oxide material based on the weight of the solution.
33. The method of clause 31 or clause 32, wherein performing the ion exchange comprises adding the cation exchange resin to the oxide material suspension solution at least four times.
34. The method of any one of clauses 31 to 33, wherein about 6 mmol glycidyltrimethylammonium chloride is mixed to the solution for every 1 gram of oxide suspension solution.
35. The method of any one of clauses 30 to 34, wherein the oxide material is selected from a group of materials consisting of aluminum oxide (Al₂O₃), silicon oxide (SiO₂ ), cerium oxide (CeO₂), zirconium oxide (ZrO₂), iron oxide (FeOx), and aluminosilicate.
36. The method of any one of clauses 30 to 34, wherein the oxide material is a combination of materials selected from a group consisting of aluminum oxide (Al₂O₃), silicon oxide (SiO₂ ), cerium oxide (CeO₂), zirconium oxide (ZrO₂), iron oxide (FeOx), and aluminosilicate, and mesoporous ceramics.
37. The method of any one of clauses 30 to 36, wherein the anions are selected from a group consisting of carbonate, oxalate, phosphate, phosphite, sulfate, sulfite, silicate, and borate.
38. The method of any one of clauses 30 to 27, wherein the anions are provided as a salt, such as a salt selected from a group of salts consisting of the sodium and/or potassium salts of phosphate, phosphite, sulfite, sulfate, borate, silicate, oxalate and carbonate.
39. A method for capture of carbon dioxide comprising:
   providing a humidity swing sorbent, the humidity swing sorbent being a material comprising:
      a sorbent carrier layer made of a material selected from a group consisting of oxide nanoparticles and nanoporous materials, and
      a capture layer, the capture layer comprising a set of neutral ionic pairs with at least one cation and at least one anion, wherein the set of neutral ionic pairs are spatially distributed through scaffolding of the oxide material such that the anions of each neutral ionic pair is spaced for formation of a hydration shell around each anion, wherein the hydration shell around the anion is a carbon dioxide adsorption site;
   exposing the humidity swing sorbent to a target gas; and
   wetting the humidity swing sorbent;
optionally wherein the method comprises the method of any one of clauses 69 to 79.
40. The method of clause 39, wherein wetting the humidity swing sorbent comprises collecting output water, which contains released target gas.
41. The method of clause 40, further comprising processing output water for capturing of the target gas.
42. The method of any one of clauses 39 to 41, wherein the target gas is carbon dioxide.
43. The method of any one of clauses 39 to 42, further comprising drying the humidity swing sorbent and reusing the humidity swing sorbent for subsequent exposure to the target gas.
44. A sorbent composition for use in adsorption of a target gas from a gas stream, wherein the sorbent composition comprises a covalent network solid oxide substrate material functionalized with an ionic linker moiety, wherein each ionic linker moiety comprises:
   a multivalent anion, and
   a polyatomic cation selected from ammonium, phosphonium, arsonium,
   stibonium, bismuthium and sulfonium;
wherein the polyatomic cation is connected to an oxygen atom on a surface of the substrate material by a covalent bond;
optionally wherein the sorbent composition is a composition according to any one of clauses to 29.
45. A sorbent precursor for a sorbent composition for use in adsorption of a target gas from a gas stream, wherein the sorbent precursor comprises a covalent network solid oxide substrate material functionalized with an ionic linker precursor, wherein each ionic linker precursor comprises:
   a monovalent anion, and
   a polyatomic cation selected from ammonium, phosphonium, arsonium,
   stibonium, bismuthium and sulfonium;
wherein the polyatomic cation is connected to an oxygen atom on a surface of the substrate material by a covalent bond;
optionally wherein the sorbent precursor is a precursor for the composition of any one of clauses 1 to 29.
46. The sorbent composition of clause 44 or the sorbent precursor of clause 45, wherein the target gas is CO₂.
47. The sorbent composition or sorbent precursor of any one of clauses 44 to 46, wherein the polyatomic cation has the formula R(R′)ₓA⁺, wherein:
   R is a hydrocarbyl-containing group connected to an oxygen atom on a surface of the substrate material by a covalent bond, or R is a covalent bond to an oxygen atom on a surface of the substrate material; and,
   each R′ is independently a hydrocarbyl-containing group or H;
and wherein:
   x is 3 and A is N, P, As, Sb or Bi; or,
   x is 2 and A is S;
      optionally wherein:
   R is an optionally substituted C1 to C8 hydrocarbyl group; and/or,
   R′ is a C1 to C6 alkyl group (such as methyl, ethyl, propyl or butyl), or R′ is an aryl group (such as phenyl).
48. The sorbent composition or sorbent precursor of any one of clauses 44 to 47, wherein:
   the polyatomic cations are spaced apart on a surface (e.g. in a pore) of the covalent network solid oxide material with an average spacing of no more than about 50 Å (angstroms), such as no more than about 20 Å, for example no more than about 10 Å; and/or
   the polyatomic cations are spaced apart by a distance of from about 4 to about 50 Å (angstroms), such as about 6 to 20 Å, for example about 8 to 10 Å.
49. The sorbent composition or sorbent precursor of any one of clauses 44 to 48, wherein the polyatomic cation is ammonium, phosphonium or sulfonium, optionally wherein the polyatomic cation is an ammonium cation, such as a quaternary ammonium cation, for example a trimethylammonium-containing cation.
50. The sorbent composition of any one of clauses 44 to 49, wherein the multivalent anion comprises or consists of oxygen and an element from Group 15 or Group 16 of the period table, for example wherein the multivalent anion is selected from: BO₃³⁻, CO₃², C₂O₄²⁻, SiO₄⁴⁻, PO₃³⁻, PO₄³⁻, SO₃²⁻ and SO₄²⁻.
51. The sorbent composition of any one of clauses 44 to 50, wherein the multivalent anion comprises or consists of hydrogen, oxygen and an element from Group 15 or Group 16 of the periodic table, for example wherein the multivalent anion is selected from: HBO₃²⁻, HCO₃₋, HC₂O₄₋, HSiO₄³⁻, HPO₃⁻, HPO₄²⁻, HSO₃₋ and HSO₄;
   wherein the sorbent composition further comprises an anion of the formula (TG)OH⁻, wherein TG is the target gas, and wherein (TG)OH⁻ and the multivalent anion are present in a molar ration of about 1:1;
   optionally wherein the target gas is CO₂ and (TG)OH⁻ is HCO₃₋.
52. The sorbent composition of any one of clauses 44 to 51, comprising the multivalent anion in an amount of from about 0.2 mmol to about 3 mmol, such as from about 0.3 to about 2.5 mmol, for example from about 0.5 to about 2 mmol, per gram of covalent network solid oxide material.
53. The sorbent composition or sorbent precursor of any one of clauses 44 to 52, wherein the substrate material is functionalized by reaction of each said oxygen on the surface of the substrate material with a carbon atom of a linker precursor reactant susceptible to nucleophilic attack, thereby forming the C—O covalent bond, for example wherein the substrate material is functionalized by reaction of each said oxygen on the surface of the substrate material with an epoxide group of a linker precursor reactant, thereby forming the C—O covalent bond.
54. The sorbent composition or sorbent precursor of clause 53, wherein the linker precursor reactant comprises a cation selected from N-[3-(Trimethoxysilyl)propyl]-N,N,N-trimethylammonium, N-(Trimethoxysilylpropyl)-N,N,N-trimethylphosphonium and glycidyltrimethylammonium, for example wherein the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond.
55. The sorbent composition or sorbent precursor of any one of clauses 44 to 54, wherein the covalent network solid oxide substrate material comprises one or more of silica, alumina, ceria, zirconia, iron oxide and aluminosilica.
56. The sorbent composition of any one of clauses 44 to 55, comprising water, wherein water is present in a molar ratio of water: multivalent anion of from 1:10 to 40:1, such as 1:1 to 1:20.
57. The sorbent composition of any one of clauses 44 to 56, comprising water, wherein water is present in a molar ratio of water: multivalent anion of greater than 40:1, such as at least 50:1.
58. A method of preparing a sorbent composition for use in adsorption of a target gas from a gas stream, wherein the method comprises:
   forming a sorbent precursor by contacting a covalent network solid oxide substrate material with a linker precursor reactant, wherein the linker precursor reactant comprises an anion and a polyatomic cation, wherein the polyatomic cation is selected from ammonium, phosphonium, arsonium, stibonium, bismuthium and sulfonium, and wherein said contacting is performed under conditions effective to form a covalent bond between an oxygen atom on a surface of the substrate material and the polyatomic cation;
   contacting sorbent precursor with an ionic compound comprising a metal from Group 1 or Group 2 of the period table and a multivalent anion, wherein said contacting is performed under conditions effective to cause ion exchange, thereby exchanging the multivalent anion for the monovalent anion; and, removing salt comprising the metal from Group 1 or Group 2 of the period table and the monovalent anion;
   optionally wherein the method comprises a method according to any one of clauses 30 to 38.
59. The method of clause 58, comprising forming a suspension of the covalent network solid oxide material in an aqueous solution (such as water), adding the linker precursor reactant to the suspension to form an intermediate mixture, and adding the ionic compound to the mixture of the suspension and the linker precursor reactant to form a product mixture.
60. The method of clause 58 or clause 59, wherein the step of removing the salt comprises centrifuging the product mixture, optionally thereby separating a by-product solution comprising water and the salt from the sorbent composition.
61. A method of preparing a sorbent precursor for a sorbent composition for use in adsorption of a target gas from a gas stream, wherein the method comprises contacting a covalent network solid oxide substrate material with a linker precursor reactant, wherein the linker precursor reactant comprises an anion and a polyatomic cation, wherein the polyatomic cation is selected from ammonium, phosphonium, arsonium, stibonium, bismuthium and sulfonium, and wherein said contacting is performed under conditions effective to form a covalent bond between an oxygen atom on a surface of the substrate material and the polyatomic cation.
62. The method of clause 61, comprising forming a suspension of the covalent network solid oxide material in an aqueous solution (such as water), and adding the linker precursor reactant to the suspension to form a mixture comprising the precursor.
63. The method of any one of clauses 58 to 62, comprising subjecting the covalent network solid oxide material to ion exchange prior to contacting the covalent network solid oxide material with the linker precursor reactant, optionally wherein the covalent network solid oxide material is subjected to ion exchange by suspending the covalent network solid oxide material in an aqueous solution (such as water) and contacting the suspension with an ion exchange resin, optionally wherein the ion exchange resin is first cleansed by contact with deionized water.
64. The method of any one of clauses 58 to 63, wherein the target gas is CO₂.
65. The method of any one of clauses 58 to 64, wherein any one of the sorbent composition, sorbent precursor, polyatomic cation, ionic compound (if present) and/or salt (if present) is as defined in any one of clauses 44 to 57.
66. The method of any one of clauses 58 to 65, comprising:
   adding the ionic linker moiety in an amount providing a weight ratio of ionic linker to covalent network oxide solid material of about 1:5 to about 1:0.04, such as about 1:4 to about 1:0.06, the ratios being, for example, weights of each material in grams; and/or adding the ionic linker moiety in an amount of about 80 to 160 mmol, for example about 100 to about 140 mmol, per gram of the covalent network solid oxide substrate material.
67. The method of any one of clauses 58 to 66, wherein the substrate material is functionalized by reaction of each said oxygen on the surface of the substrate material with a carbon atom of a linker precursor reactant susceptible to nucleophilic attack, thereby forming the C—O covalent bond, for example wherein the substrate material is functionalized by reaction of each said oxygen on the surface of the substrate material with an epoxide group of a linker precursor reactant, thereby forming the C—O covalent bond.
68. The method of any one of clauses 58 to 67, wherein the linker precursor reactant comprises a cation selected from N-[3-(Trimethoxysilyl)propyl]-N,N,N-trimethylammonium, N-(Trimethoxysilylpropyl)-N, N,N-trimethylphosphonium and glycidyltrimethylammonium, for example wherein the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond.
69. A method of removing a target gas from a gas stream having a first concentration of target gas, wherein the method comprises contacting the gas stream with a sorbent composition;
   wherein the sorbent composition comprises a covalent network solid oxide substrate material functionalized with an ionic linker moiety, wherein each ionic linker moiety comprises:
      a multivalent anion, and
      a polyatomic cation selected from ammonium, phosphonium, arsonium, stibonium, bismuthium and sulfonium;
      wherein the polyatomic cation is connected to an oxygen atom on a surface of the substrate material by a covalent bond;
   wherein the target gas is adsorbed by the sorbent composition, thereby forming a target gas enriched sorbent composition and a product gas stream having a second target gas concentration,
   and wherein the second target gas concentration is lower than the first target gas concentration.
70. The method of clause 69, wherein the target gas is CO₂.
71. The method of clause 69 or clause 70, wherein the sorbent composition is as defined in clause 44 or any one of clauses 46 to 56.
72. A method of removing a target gas from a target gas enriched sorbent composition, wherein the method comprises contacting the target gas enriched sorbent composition with a gas stream and water, wherein the gas stream has a first concentration of target gas;
   wherein the target gas enriched sorbent composition comprises a covalent network solid oxide substrate material functionalized with an ionic linker moiety, wherein each ionic linker moiety comprises:
   a multivalent anion, and
   a polyatomic cation selected from ammonium, phosphonium, arsonium, stibonium, bismuthium and sulfonium;
   wherein the polyatomic cation is connected to an oxygen atom on a surface of the substrate material by a covalent bond;
   wherein the target gas is released from the target gas enriched sorbent composition, thereby forming a wetted sorbent composition and a product stream (such as a product gas stream) having a second target gas concentration, and wherein the second target gas concentration is higher than the first target gas concentration.
73. The method of clause 72, wherein the target gas is CO₂.
74. The method of clause 72 or clause 73, wherein the sorbent composition is as defined in clause 44, any one of clauses 46 to 55, or clause 57.
75. The method of any one of clauses 72 to 74, further comprising drying the wetted sorbent composition to form a sorbent composition.
76. The method of clause 75, wherein the sorbent composition comprises water, wherein water is present in a molar ratio of water: multivalent anion of from 1:10 to 40:1, such as 1:1 to 1:20.
77. A method of treating a gas stream comprising performing the method of any one of clauses 69 to 71, and subsequently performing the method of any one of clauses 72 to 74; optionally wherein the method comprises a method according to any of clauses 39 to 43.
78. The method of clause 77, comprising performing the method of clause 75 or 76 after the step of performing the method of any of clauses 72 to 74, and optionally reusing the sorbent composition so formed to repeat performance of the method of any one of clauses 69 to 71.
79. The method of clause 78, comprising separating the target gas from the product stream.
80. A porous membrane for use in apparatus for separating a target gas from a gas stream, wherein the porous membrane comprises a sorbent composition of claim 1.
81. The porous membrane of clause 80, wherein the target gas is CO₂.
82. The porous membrane of clause 80 or clause 81, comprising or consisting of the sorbent composition.
83. The porous membrane of clause 80 or clause 81, wherein the sorbent composition is supported on membrane material, such as a polymeric membrane material.
84. Apparatus for separation of a target gas from a gas stream, wherein the apparatus comprises a sorbent composition according to clause 44 or any one of clauses 46 to 57, wherein the sorbent composition is arranged for contact with the gas stream.
85. The apparatus of clause 84, wherein the target gas is CO₂.
86. The apparatus of clause 84 or clause 85, comprising the porous membrane of any one of clauses 80 to 83.

1. A sorbent composition for use in adsorption of a target gas from a gas stream, wherein the sorbent composition comprises a covalent network solid oxide substrate material functionalized with an ionic linker moiety, wherein each ionic linker moiety comprises:
a multivalent anion, and
a polyatomic cation selected from ammonium, phosphonium, arsonium, stibonium, bismuthium and sulfonium;
wherein the polyatomic cation is connected to an oxygen atom on a surface of the substrate material by a covalent bond.

2. The sorbent composition of claim 1, wherein the target gas is CO₂.

3. The sorbent composition of claim 1, wherein the polyatomic cation has the formula R(R′)ₓA⁺, wherein:
R is a hydrocarbyl-containing group connected to an oxygen atom on a surface of the substrate material by a covalent bond, or R is a covalent bond to an oxygen atom on a surface of the substrate material; and,
each R′ is independently a hydrocarbyl-containing group or H;
and wherein:
x is 3 and A is N, P, As, Sb or Bi; or,
x is 2 and A is S.

4. The sorbent composition of claim 3, wherein:
R is an optionally substituted C1 to C8 hydrocarbyl group; and/or,
R′ is a C1 to C6 alkyl group (such as methyl, ethyl, propyl or butyl), or R′ is an aryl group (such as phenyl).

5. The sorbent composition of claim 1, wherein the polyatomic cation is ammonium, phosphonium or sulfonium, optionally wherein the polyatomic cation is an ammonium cation, such as a quaternary ammonium cation, for example a trimethylammonium-containing cation.

6. The sorbent composition of claim 1, wherein:
the polyatomic cations are spaced apart on the covalent network solid oxide material with an average spacing of no more than about 50 Å, such as no more than about 20 Å, for example no more than about 10 Å; and/or the polyatomic cations are spaced apart on the covalent network solid oxide material with an average spacing of from about 4 to about 50 Å, such as about 6 to 20 Å, for example about 8 to 10 Å.

7. The sorbent composition of claim 1, wherein the multivalent anion comprises oxygen and an element from Group 15 or Group 16 of the period table, for example wherein the multivalent anion is selected from: BO₃³⁻, CO₃², C₂O₄²⁻, SiO₄⁴⁻, PO₃³⁻, PO₄³⁻, SO₃²⁻ and SO₄²⁻.

8. The sorbent composition of claim 1, wherein the multivalent anion comprises hydrogen, oxygen and an element from Group 15 or Group 16 of the periodic table, for example wherein the multivalent anion is selected from: HBO₃²⁻, HCO₃₋, HC₂O₄₋, HSiO₄³⁻, HPO₃⁻, HPO₄²⁻, HSO₃₋ and HSO₄₋;
wherein the sorbent composition further comprises an anion of the formula (TG)OH⁻, wherein TG is the target gas, and wherein (TG)OH⁻ and the multivalent anion are present in a molar ration of about 1:1;
optionally wherein the target gas is CO₂ and (TG)OH⁻ is HCO₃₋.

9. The sorbent composition of claim 1, comprising the multivalent anion in an amount of from about 0.2 mmol to about 3 mmol, such as from about 0.3 to about 2.5 mmol, for example from about 0.5 to about 2 mmol, per gram of covalent network solid oxide material.

10. The sorbent composition of claim 1, wherein the substrate material is functionalized by reaction of each said oxygen on the surface of the substrate material with a carbon atom of a linker precursor reactant susceptible to nucleophilic attack, thereby forming the C—O covalent bond.

11. The sorbent composition of claim 10, wherein the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond.

12. The sorbent composition of claim 1, wherein the covalent network solid oxide substrate material comprises one or more of silica, alumina, ceria, zirconia, iron oxide and aluminosilica.

13. The sorbent composition of claim 1, comprising water, wherein water is present in a molar ratio of water: multivalent anion of from 1:10 to 40:1, such as 1:1 to 1:20, or wherein water is present in a molar ratio of water: multivalent anion of greater than 40:1, such as at least 50:1.

14. (canceled)

15. A sorbent precursor for a sorbent composition for use in adsorption of a target gas from a gas stream, wherein the sorbent precursor comprises a covalent network solid oxide substrate material functionalized with an ionic linker precursor, wherein each ionic linker precursor comprises:
a monovalent anion, and
a polyatomic cation selected from ammonium, phosphonium, arsonium, stibonium, bismuthium and sulfonium;
wherein the polyatomic cation is connected to an oxygen atom on a surface of the substrate material by a covalent bond.

16. The sorbent precursor of claim 15, wherein the target gas is CO₂.

17. The sorbent precursor of claim 15, wherein the monovalent anion is a halide, such as chloride.

18. The sorbent precursor of claim 15, wherein the polyatomic cation has the formula R(R′)ₓA⁺, wherein:
R is a hydrocarbyl-containing group connected to an oxygen atom on a surface of the substrate material by a covalent bond, or R is a covalent bond to an oxygen atom on a surface of the substrate material; and,
each R′ is independently a hydrocarbyl-containing group or H;
and wherein:
x is 3 and A is N, P, As, Sb or Bi; or,
x is 2 and A is S.

19. The sorbent precursor of claim 18, wherein:
R is an optionally substituted C1 to C8 hydrocarbyl group; and/or,
R′ is a C1 to C6 alkyl group (such as methyl, ethyl, propyl or butyl), or R′ is an aryl group (such as phenyl).

20. The sorbent precursor of claim 15, wherein:
the polyatomic cations are spaced apart on the covalent network solid oxide material with an average spacing of no more than about 50 Å, such as no more than about 20 Å, for example no more than about 10 Å; and/or
the polyatomic cations are spaced apart on the covalent network solid oxide material with an average spacing of from about 4 to about 50 Å, such as about 6 to 20 Å, for example about 8 to 10 Å.

21. The sorbent precursor of claim 15, wherein the polyatomic cation is ammonium, phosphonium or sulfonium, optionally wherein the polyatomic cation is an ammonium cation, such as a quaternary ammonium cation, for example a trimethylammonium-containing cation.

22. The sorbent precursor of claim 14, comprising the ionic linker precursor in an amount of about 2-10 mmol per gram of the covalent network solid oxide substrate material, for example about 5 to 7 mmol per gram.

23. The sorbent precursor of claim 15, wherein the substrate material is functionalized by reaction of each said oxygen on the surface of the substrate material with a carbon atom of a linker precursor reactant susceptible to nucleophilic attack, thereby forming the C—O covalent bond.

24. The sorbent precursor of claim 23, wherein the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond.

25. The sorbent precursor of claim 15, wherein the covalent network solid oxide substrate material comprises one or more of silica, alumina, ceria, zirconia, iron oxide and aluminosilicate.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A method of preparing a sorbent precursor for a sorbent composition for use in adsorption of a target gas from a gas stream, wherein the method comprises contacting a covalent network solid oxide substrate material with a linker precursor reactant, wherein the linker precursor reactant comprises an anion and a polyatomic cation, wherein the polyatomic cation is selected from ammonium, phosphonium, arsonium, stibonium, bismuthium and sulfonium, and wherein said contacting is performed under conditions effective to form a covalent bond between an oxygen atom on a surface of the substrate material and the polyatomic cation.

44. The method of claim 43, comprising forming a suspension of the covalent network solid oxide material in an aqueous solution (such as water), and adding the linker precursor reactant to the suspension to form a mixture comprising the precursor.

45. The method of claim 43, comprising subjecting the covalent network solid oxide material to ion exchange prior to contacting the covalent network solid oxide material with the linker precursor reactant, optionally wherein the covalent network solid oxide material is subjected to ion exchange by suspending the covalent network solid oxide material in an aqueous solution (such as water) and contacting the suspension with an ion exchange resin, optionally wherein the ion exchange resin is first cleansed by contact with deionized water.

46. The method of claim 43, wherein the target gas is CO₂.

47. (canceled)

48. (canceled)

49. (canceled)

50. The method of claim 43, comprising:
adding the ionic linker moiety in an amount providing a weight ratio of ionic linker to covalent network oxide solid material of about 1:5 to about 1:0.04, such as about 1:4 to about 1:0.06; and/or
adding the ionic linker moiety in an amount of about 80 to 160 mmol, for example about 100 to about 140 mmol, per gram of the covalent network solid oxide substrate material.

51. The method of claim 43, wherein the substrate material is functionalized by reaction of each said oxygen on the surface of the substrate material with a carbon atom of a linker precursor reactant susceptible to nucleophilic attack, thereby forming the C—O covalent bond.

52. The method of claim 51, wherein the linker precursor reactant comprises a glycidyltrimethylammonium cation, and wherein the substrate material is functionalized by reaction of each said oxygen on the surface of the substrate material with the epoxide group of the glycidyltrimethylammonium cation, thereby forming the C—O covalent bond.

53.-91. (canceled)

92. The method of claim 43, further comprising converting the sorbent precursor to a sorbent composition for use in adsorption of a target gas from a gas stream, wherein the method comprises:
contacting the sorbent precursor with an ionic compound comprising a metal from Group 1 or Group 2 of the period table and a multivalent anion, wherein said contacting is performed under conditions effective to cause ion exchange, thereby exchanging the multivalent anion for the monovalent anion; and,
removing salt comprising the metal from Group 1 or Group 2 of the periodic table and the monovalent anion.
